(19) United States
(12) Patent Application Publication
(10) Pub. No.: US 2024/0172036 A1
(43) Pub. Date: May 23, 2024

(54) DEVICE TRACKING AND MANAGEMENT IN A WIRELESS NETWORK ENVIRONMENT

(71) Applicant: Charter Communications Operating, LLC, St. Louis, MO (US)

(72) Inventors: Christopher J. Teague, Castle Pines, CO (US); Ahmed Bencheikh, Lorton, VA (US); Shane B. Newberg, Aurora, CO (US); Peter Andrew Ericksen, Castle Rock, CO (US); Venkata R. Divvi, Centennial, CO (US); Donald W. Sherker, Parker, CO (US)

(21) Appl. No.: 17/988,947

(22) Filed: Nov. 17, 2022

(51) Int. Cl. H04W 28/02; H04W 24/02; H04W 64/00

(52) U.S. Cl. CPC H04W 28/0268; H04W 24/02; H04W 64/003; H04W 88/16

(57) ABSTRACT

A tracking system monitors operating conditions of a first wireless access point through which a mobile communication device communicates with a gateway. The gateway and the first wireless access point support a session of data flows between the mobile communication device and a remote network. Based on the monitored operating conditions of the wireless access point, the controller associated with the tracking system dynamically generates control settings to control the session of data flows through the gateway. The controller applies the control settings to the gateway to control communications associated with the session of data flows between the remote network and the mobile communication device. The controller applies different control settings under different operating conditions and/or as the mobile communication device uses different wireless access points to communicate through the gateway to the remote network.

### BACKGROUND

Conventional wireless networks typically include one or more wireless base stations or wireless access points to provide mobile communication devices (a.k.a., user equipment) access to a remote network such as the Internet. Such wireless access points or base stations can be deployed indoors or outdoors depending on the type of access to be provided.

In certain instances, a user associated operating a respective mobile communication device subscribes to use of first wireless access points provided by a first wireless network service provider. One or more of the first wireless access points operated by the first wireless network service provider may reside at any location such as in a corresponding subscriber domain in which the user domiciles. One or more of the first wireless access points operated by the first wireless network service provider may reside outside of the subscriber domain as well. In such an instance, the operator of the mobile communication devices is provided wireless access during conditions in which the user resides within the subscriber domain or is within wireless range of wireless access points provided by the first wireless network service provider outside of the subscriber domain.

To provide yet better coverage, the first wireless network service provider made partner with a second wireless network service provider. In such an instance, the user of the mobile communication devices is able to use second wireless access points (which are located outside of the subscriber domain) operated by the second wireless network service provider.

### BRIEF DESCRIPTION OF EMBODIMENTS

Embodiments herein include a solution to implement dynamic implementation of wireless policies based on many factors associated with respective wireless networks to which a customer is connected. For example, a tracking system as described herein provides real time awareness of available wireless networks and renders granular policy decisions and corresponding control of data flows associated with different mobile communication devices based on data inputs when clients (mobile communication devices) attach to the different wireless networks and roam from one wireless base station to another.

More specifically, in one implementation, a tracking system (such as communication management resource) monitors operating conditions of a first wireless access point through which a mobile communication device communicates with a gateway (such as a so-called wireless access gateway). While the mobile communication device is wirelessly connected to the first wireless access point, the combination of gateway and the first wireless access point support a first session of data flows between the mobile communication device through the gateway to a remote network. Based on the monitored operating conditions of the wireless access point, a controller associated with the tracking system dynamically generates control settings to control the session of data flows through the gateway. For example, the controller applies initial and/or updated data flow control settings to the gateway to control communications associated with the mobile communication device and the remote network.

Note that the gateway can be configured to control communications in either direction. For example, in one implementation, the gateway controls communications in a first direction from the mobile communication device through the first wireless access point and the gateway to the remote network. Conversely, the gateway can be configured to control communications in a second direction such as from the remote network through the gateway and the first wireless access point to the mobile communication device.

The controller applies different control settings to the gateway under different operating conditions and/or as the mobile communication device uses different wireless access points to communicate through the gateway to the remote network.

As further discussed herein, in one implementation, based on feedback from the first wireless access point, the communication management resource determines a quality of service associated with the session of data flows to be provided to the mobile communication device. Yet further, the communication management resource compares the determined quality of service associated with the data flows to a threshold service level to which a user of the mobile communication device subscribes and adjusts the control settings applied to the gateway to support the threshold service level.

In yet further examples, the communication management resource as described herein applies the adjusted control settings to the gateway to control the communications associated with the data flows through the gateway based on detected operating conditions of the different wireless access points.

In further example embodiments, the first wireless access point is coupled to the gateway via a shared communication link. The data flows associated with the mobile communication device are first data flows. The communication management resource further performs operations of: detecting a handoff of the mobile communication device from the first wireless access point to a second wireless access point; monitoring operating conditions of the second wireless access point through which the mobile communication device communicates with the gateway, a combination of the gateway and the second wireless access point supporting a second session of data flows between the mobile communication device and the remote network; based on the monitored operating conditions of the second wireless access point, dynamically generating second settings to control the second session of data flows; and applying the second control settings to the gateway to control communications associated with the second session of data flows between the mobile communication device and the remote network.

Each of the wireless access points as described herein may reside in any suitable location. In one embodiment, the first wireless access point operated by a first wireless network service provider resides in a subscriber domain in which a user of the mobile communication device domiciles; the second wireless access point operated by the first wireless network service provider resides outside the subscriber domain.

The communication system as described herein can be configured to support any suitable type of wireless application protocol. In one nonlimiting example embodiment, the mobile communication device is in wireless communication with the first wireless access point via a Wi-Fi™ communication protocol.

As further discussed herein, the communication management resource (i.e., tracking system as discussed herein) can be configured to track movement of the mobile communication device through a wireless network environment of multiple wireless access points including the first wireless access point. In one configuration, the movement of the mobile communication device is tracked based on detected handoffs of the mobile communication device from one wireless access point to another wireless access point in the wireless network environment. As previously discussed, the communication management resource further performs operations of: monitoring operating conditions of each of the multiple wireless access points providing wireless services; and updating respective control settings (of the mobile communication device) applied to the gateway based on the operating conditions of the multiple wireless access points.

In still further examples, the communication management resource generates the data flow control settings for application to the gateway in response to receiving a message from the gateway. The message provides notification of the gateway receiving at least initial communications from the wireless access point. The initial communications are generated by the mobile communication device and are transmitted through the wireless access point to the gateway for delivery to an appropriate destination in the remote network.

In further example embodiments, the operating conditions include a capability of the first wireless access point to support wireless communications with the mobile communication device. The system as discussed herein generates corresponding control settings for each of multiple mobile communication devices on a per mobile communication device basis.

As previously discussed, the monitored operating conditions can be configured to include an ability of the first wireless access point to support communications between the first wireless access point and the gateway.

Yet further, the communication management hardware can be configured to: determine capabilities of the mobile communication device to support communications; and dynamically generate the control settings to control the session of data flows through the gateway based on the monitored operating conditions and the determined capabilities of the mobile communication device.

In further example embodiments, the system as discussed herein is configured to: track multiple mobile communication devices in wireless communication with multiple wireless access points, each of the wireless access points in communication with a gateway controlling connectivity of the mobile communication devices to a remote network; dynamically generating control settings to control data flows of the multiple mobile communication devices through the gateway based on monitored operating conditions of the wireless access points; and provide the control settings to the gateway to control the data flows of the multiple mobile communication devices.

In one embodiment, dynamically generating control settings includes: generating first control settings to control a first data flow associated with a first mobile communication device of the multiple mobile communication devices; applying the first control settings at the gateway to control the first data flow, the first data flow supporting first communications through the gateway between the first mobile communication device and the remote network; generating second control settings to control a second data flow associated with a second mobile communication device, the second control settings different than the first control settings; and applying the second control settings at the gateway to control the second data flow, the second data flow supporting second communications through the gateway between the second mobile communication device and the remote network.

Embodiments herein are useful over conventional techniques. For example, the communication management resource as discussed herein provides unique control of providing wireless access to a mobile communication device based on network operating conditions and/or a location of the mobile communication device.

Note that any of the resources as discussed herein can include one or more computerized devices, mobile communication devices, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different embodiments as described herein.

Yet other embodiments herein include software programs to perform the steps and operations summarized above and disclosed in detail below. One such embodiment comprises a computer program product including a non-transitory computer-readable storage medium (i.e., any computer readable hardware storage medium) on which software instructions are encoded for subsequent execution. The instructions, when executed in a computerized device (hardware) having a processor, program and/or cause the processor (hardware) to perform the operations disclosed herein. Such arrangements are typically provided as software, code, instructions, firmware, and/or other data (e.g., data structures) arranged or encoded on a non-transitory computer readable storage medium such as an optical medium (e.g., CD-ROM), floppy disk, hard disk, memory stick, memory device, etc., or other a medium such as one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, embodiments herein are directed to a method, system, computer program product, etc., that supports operations as discussed herein.

One embodiment includes a computer readable storage medium and/or system having instructions stored thereon. The instructions, when executed by computer processor hardware, cause the computer processor hardware (such as one or more co-located or disparately processor devices or hardware) to: monitor operating conditions of a first wireless access point through which a mobile communication device communicates with a gateway, the gateway and the first wireless access point supporting a session of data flows between the mobile communication device and a remote network; based on the monitored operating conditions, dynamically generate control settings to control the session of data flows through the gateway; and apply the control settings to the gateway to control communications associated with the session of data flows between the remote network and the mobile communication device.

One embodiment includes a computer readable storage medium and/or system having instructions stored thereon. The instructions, when executed by computer processor hardware, cause the computer processor hardware (such as one or more co-located or disparately processor devices or hardware) to: track multiple mobile communication devices in wireless communication with multiple wireless access points, each of the wireless access points in communication with a gateway controlling connectivity of the mobile communication devices to a remote network; dynamically generate control settings to control data flows of the multiple mobile communication devices through the gateway based on monitored operating conditions of the wireless access points; and provide the control settings to the gateway to control the data flows of the multiple mobile communication devices.

The ordering of the steps above has been added for clarity sake. Note that any of the processing steps as discussed herein can be performed in any suitable order.

Other embodiments of the present disclosure include software programs and/or respective hardware to perform any of the method embodiment steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing wireless services to communication devices. However, it should be noted that embodiments herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of embodiments herein (BRIEF DESCRIPTION OF EMBODIMENTS) purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section (which is a summary of embodiments) and corresponding figures of the present disclosure as further discussed below.

### BRIEF DESCRIPTION OF THE DRAWINGS

FIG. 1 is an example diagram illustrating a wireless network environment and tracking of communication devices to provide wireless services according to embodiments herein.

FIG. 2 is an example diagram illustrating tracking information and flow control settings for application to a gateway according to embodiments herein.

FIG. 3 is an example diagram illustrating distribution and implementation of data flow policies at a gateway to support wireless connectivity in a network environment according to embodiments herein.

FIG. 4 is an example diagram illustrating flow control settings for application to a gateway according to embodiments herein.

FIG. 5 is an example diagram illustrating updating of a respective data flow policy in response to a detected event and application of the updated data flow policy at a gateway according to embodiments herein.

FIG. 6 is an example diagram illustrating updated data flow control settings according to embodiments herein.

FIG. 7 is an example diagram illustrating a handoff of a communication device to from a first wireless access point in a subscriber domain to a second wireless access point disposed outside of the subscriber domain and implementation of corresponding data flow control settings according to embodiments herein.

FIG. 8 is an example diagram illustrating updated data flow control settings for application to a respective gateway according to embodiments herein.

FIG. 9 is an example diagram illustrating a handoff of a communication device from the second wireless access point to a third wireless access point disposed outside of a subscriber domain and application of data flow control settings according to embodiments herein.

FIG. 10 is an example diagram illustrating tracking information and updated flow control settings for application to a respective gateway according to embodiments herein.

FIG. 11 is an example diagram illustrating example computer architecture operable to execute one or more operations according to embodiments herein.

FIG. 12 is an example diagram illustrating a method according to embodiments herein.

FIG. 13 is an example diagram illustrating a method according to embodiments herein.

FIG. 14 is an example diagram illustrating a wireless network environment and tracking of communication devices to provide wireless services according to embodiments herein.

FIG. 15 is an example diagram illustrating tracking information and flow control settings (i.e., configuration settings) for application to a gateway according to embodiments herein.

FIG. 16 is an example diagram illustrating distribution and implementation of data flow policies (data flow control settings) to support wireless connectivity in a network environment according to embodiments herein.

FIG. 17 is an example diagram illustrating flow control settings for application to a gateway according to embodiments herein.

FIG. 18 is an example diagram illustrating updating of a respective data flow policy in response to a detected event and application of the updated data flow policy at a gateway according to embodiments herein.

FIG. 19 is an example diagram illustrating updated data flow control settings according to embodiments herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DETAILED DESCRIPTION

Wireless networks are increasing day by day in terms of coverage, capacity, and usage by customers. One possible solution to providing better wireless service to customers is to build a system that has real time awareness of available wireless networks and is able to make granular policy decisions based on data inputs when clients attach to our wireless networks and roam from radio to radio. As discussed herein, this disclosure includes a system that accepts many forms of data input to build a real time understanding of the operating wireless networks in a service provider. Common protocols are used to collect this information, which can include but is not limited to: Syslog, SNMP traps, API communication, Kafka message bus, RADIUS, etc.

In one embodiment, the system builds a database using data input answering any of one or more of these four questions:

What access point is a respective mobile communication device (a.k.a. user equipment) attached to?

Which mobile communication devices are attached to a particular access point? Which mobile communication devices are attached to a certain type of access point?

What is the general health of a certain access point?
#of clients, radio metrics (interference), etc

How does this disclosure overcome the challenges of providing better wireless services to mobile communication devices? i) The system enables reference to a real time database of device and access point connectivity and conditions to make proactive policy decisions. ii) These policies can be defined by organizations such as product, operations, and/or technology. iii) The policies can restrict data rates to circumvent technical challenges which requires future software enhancements.

Example 1— Assume that a router with a specific chipset is unable to place GREv6 traffic into fast path (hardware acceleration). If a client is offered and subscribes to a default policy of 1 Gbps in the downlink and the client performs a speed test or download that achieves 1 Gbps, the non-hardware accelerated GREv6 traffic will cause high CPU conditions impacting the private network. The vendor of the specific chipset may require a software update to enable placing GREv6 in fast path but may be unavailable. Implementation of generation and application of dynamic data flow control policies as described herein enables the service at a lesser speed tier without impacting the customer experience.

Example 2— Assume that a router has Mobile Speed Boost and Mobile Home services enabled simultaneously. If there are users attached to Mobile Home and Mobile Speed Boost, the default Mobile Home policy will cause latency and throughput limitation on the Mobile Speed Boost. The wireless tracking system as discussed herein will understand if Mobile Speed Boost sessions are active and inform the Spectrum Mobile Home platform to offer a restricted speed policy allowing the two services to come online without impacting one another.

According to one configuration, a tracking system monitors operating conditions of one or more wireless access points including a first wireless access point through which a mobile communication device communicates with a gateway. Based on initial data flow control settings (a.k.a., configuration settings) generated and/or supplied by the tracking system, the gateway and the first wireless access point support a session of data flows between the mobile communication device and a remote network. Based on the monitored operating conditions of the wireless access point, the controller (such as controller function associated with one or more entities) associated with the tracking system dynamically generates updated or modified control settings to control the session of data flows through the gateway such as depending on changing network conditions. The controller function (such as authentication function, policy engine, etc.) applies the dynamically generated control settings to the gateway to control communications associated with the session of data flows (such as one or more communications) between the remote network and the mobile communication device as well as between the mobile communication device and the remote network. Thus, the controller applies different control settings under different operating conditions and/or as the mobile communication device uses different wireless access points to communicate through the gateway to the remote network.

In one embodiment, as further discussed herein, a Sequence of flow includes—Controller/AP relaying telemetry data to “Tracking System,” AAA/Policy engine fetching the control settings (aka policy), and the AAA/Policy engine delivering appropriate control settings (policy) to a respective Gateway on a per UE basis. More specifically, the tracking system as discussed herein tracks locations of each of the mobile communication devices connected to the different wireless access points, monitors corresponding operating conditions of those wireless access points, and dynamically adjusts corresponding data flow control settings provided to the mobile communication devices through a gateway depending upon whether the monitored operating conditions of the wireless access points providing wireless service are favorable or unfavorable.

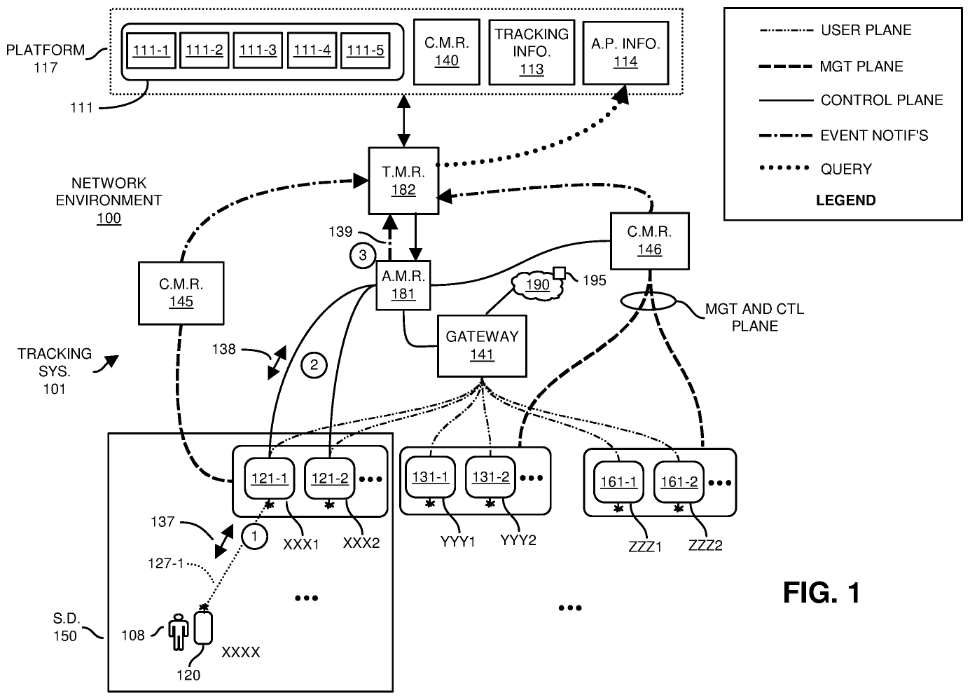

Now, more specifically, FIG. 1 is an example diagram illustrating a wireless network environment and tracking of communication devices to provide wireless services according to embodiments herein.

As shown, wireless network environment 100 includes communication management resource 140 (such as a policy rules engine or other suitable entity), communication management resource 145, communication management resource 146, tracking management resource 182 (i.e., a communication management resource), authentication management resource 181, gateway 141, network 190, wireless access points 121 (e.g., wireless access point 121-1, wireless access point 121-2, etc.), wireless access points 131 (e.g., wireless access point 131-1, wireless access point 131-2, etc.), wireless access points 161 (e.g., wireless access point 161-1, wireless access point 161-2, etc.), and subscriber domain 150.

The wireless network environment 100 can be configured to include any number of subscriber domains and corresponding wireless access points (similar to subscriber domain 150 and corresponding wireless access points 121) operated by a first wireless network service provider to provide corresponding mobile communication devices and subscriber users access to the remote network 190 through the gateway 141 (a.k.a., wireless access gateway).

Note that a combination of one or more of the wireless access points 121, 131, 161, gateway 141, authentication management resource 181, tracking management resource 182, communication management resource 140, communication management resource 145, communication management resource 146, etc., provide communication management functions associated with multiple mobile communication devices as discussed herein.

Each of the wireless access points as described herein may reside in any suitable location. In one embodiment, the wireless access points 121 reside in the subscriber domain 150 in which a user 108 of the mobile communication device 120 domiciles; each of the wireless access points 131 and wireless access points 161 reside outside the subscriber domain 150.

Note further that each of the resources as described herein can be configured as hardware, software, or combination of both hardware and software. More specifically, the communication management resource 140 can be implemented as communication management hardware, communication management software, or combination of communication management hardware and communication management software; communication management resource 145 can be implemented as communication management hardware, communication management software, or combination of communication management hardware and communication management software; communication management resource 146 can be implemented as communication management hardware, communication management software, or combination of communication management hardware and communication management software; tracking management resource 182 can be implemented as tracking management hardware, tracking management software, or combination of tracking management hardware and tracking management software; authentication management resource 181 can be configured as authentication management hardware, authentication management software, or combination of authentication management hardware and authentication management software; gateway 141 can be configured as gateway hardware, gateway software, or combination of gateway hardware and gateway software; each of the wireless access points (such as any of wireless access points 121, wireless access points 131, or wireless access points 161) can be configured as wireless access point hardware, wireless access point software, or a combination of wireless access point hardware and wireless access point software; mobile communication device 120 can be configured as mobile communication hardware, mobile communication software or a combination of mobile communication hardware and mobile communication software; and so on.

As further shown, network environment 100 includes platform 117. Platform 117 includes multiple resources such as data collectors 111 including one or more of data collector 111-1 (such as a Kafka message bus), data collector 111-2 (such as Syslog), data collector 111-3 (such as Simple Network Management Protocol traps), data collector 111-4 (such as Application Programming Interface), data collector 111-5, etc.

In this example embodiment, platform 117 further includes the communication management resource 140 as well as one or more repositories to store tracking information 113 as well as access point information 114 collected by the data collectors 111 and/or communication management resources 145 and 146.

In this example, the subscriber domain 150 includes installation of multiple wireless access points including wireless access point 121-1 assigned network address XXX1, wireless access point 121-2 assigned network address XXX2, etc.

Each of the wireless access points 121 is operated by a first wireless network service provider to which the corresponding owner (such as user 108) of subscriber domain 150 subscribes. Further, the wireless access points 121 provide any of multiple mobile communication devices wireless connectivity to the remote network 190 and corresponding server resources 195 while those mobile communication devices are located in the subscriber domain 150 or within range of the wireless access points 121.

Wireless network environment 100 further includes multiple wireless access points 131 disposed outside of the subscriber domain 150. The multiple wireless access points 131 in this example are operated by the first wireless network service provider and support wireless connectivity of the multiple mobile communication device 120 (as well as any other mobile communication devices operated by subscribers of the first wireless network service provider) to the remote network 190 (and corresponding server resources 195) when respective user 108 and/or mobile communication device 120 is operated outside of the respective subscriber domain 150. In this example, the wireless access points 131 include wireless access point 131-1 assigned network address YYY1, wireless access point 131-2 assigned network address YYY2, and so on.

Wireless network environment 100 further includes multiple wireless access points 161 disposed outside of the subscriber domain 150. The multiple wireless access points 161 are operated by a second wireless network service provider (different than the first wireless network service provider) and support wireless connectivity of the mobile communication device 120 (as well as other mobile communication devices) to the remote network 190 (and corresponding server resources 195) when the mobile communication device 120 and/or respective user 108 are located outside the wireless coverage provided by the wireless access points 121 and wireless access points 131. In this example, the wireless access points 161 include wireless access point 161-1 assigned network address ZZZ1, wireless access point 131-2 assigned network address ZZZ2, and so on.

As further discussed herein, in one implementation, the tracking system 101 (such as including communication management resource 140) monitors operating conditions of the multiple wireless access points 121, 131, 161, etc. For example, the tracking system 101 monitors operating conditions of a first wireless access point 121-1 through which a mobile communication device 120 communicates with a gateway 141 (such as wireless access gateway that controls a rate of wireless communications over wireless communication link 127-1). The combination of gateway 141 and the first wireless access point 121 support a first session of data flows between the mobile communication device 120 through the gateway 121 to a remote network 190 (such as the Internet or other network). Based on the monitored operating conditions of the wireless access point 121, the controller (communication management resource 140 or other suitable entity) associated with the tracking system 101 dynamically generates control settings to control the session of data flows through the gateway.

For example, the controller (a.k.a., communication management resource 140) can be configured to apply the control settings to the gateway 141 to control communications associated with the session of data flows between the mobile communication device 120 and the remote network 190. The gateway 141 can be configured to control communications in either direction such as from the mobile communication device 120 through the first wireless access point 121-1 and the gateway 141 to the remote network 190. Additionally, the gateway can be configured to control communications from the remote network 190 through the gateway 141 and the first wireless access point 121-1 to the mobile communication device 120. As further discussed herein, the controller applies different control settings under different operating conditions and/or as the mobile communication device uses different wireless access points to communicate through the gateway to the remote network.

Initially, in processing operation #1,assume that the user 108 operates the mobile communication device 120 to establish the wireless communication link 127-1 with the wireless access point 121-1 disposed in the subscriber domain 150. The wireless communication link 127-1 supports communications 137 between the mobile communication device 120 and the wireless access point 121-1.

In one example, prior to providing the mobile communication device 120 and corresponding user 108 access to the remote network 190 through the gateway 141, the wireless access point 121-1 must first authenticate the user 108 and/or corresponding communication device 120 to use wireless services provided by the first wireless network service provider operating the wireless access points 121.

Note that each of the wireless access points 121, 131, 161, etc., can be configured to support any suitable one or more wireless communication protocols. For example, the one or more wireless access points in wireless network environment 100 can be configured to support Wi-Fi™, LTE (Long Term Evolution) communications, 4G communications, 5G communications, and so on.

As further shown, in processing operation #2,the wireless access point 121-1 supports authentication of the mobile communication device 120 and/or corresponding user 108. For example, the mobile communication device 120 and/or corresponding wireless access point 121-1 generate an authentication request to use wireless services associated with the wireless access point 121-1. Via communications 138, the wireless access point 121-1 forwards an authentication request associated with authentication of the mobile communication device 120 from the wireless access point 121-1 to the authentication management resource 181.

Note that authentication of the mobile communication device 120 and/or corresponding user 108 can be implemented in any suitable manner. For example, in one embodiment, in response to receiving the authentication request associated with the mobile communication device 120, via communications from the authentication management resource 181 through the wireless access point 121-1 to the mobile communication device 120, the authentication management resource 181 requests that the mobile communication device 120 provide authentication credentials to the authentication management resource 181. Via communications 137 and communications 138, the authentication management resource 181 receives authentication credentials from the mobile communication device 120. The authentication management resource 181 verifies that the user 108 and corresponding mobile communication device 120 are authorized to use the gateway 141 and corresponding wireless access point 121-1. For example, based on the supplied authentication credentials, the authentication management resource 181 determines that the mobile communication device 120 assigned network address XXXX and corresponding user 108 are authorized to use the wireless services provided by the wireless access point 121-1.

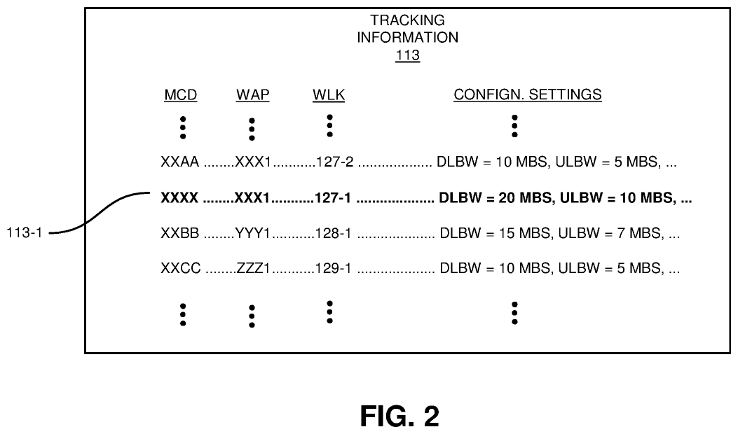

As further shown, in processing operation #3,via communications 139, the authentication management resource 181 forwards notification of the established in authorized wireless communication link 127-1 and corresponding attributes of the mobile communication device 120 to the tracking management resource 182. For example, the notification in communications 139 to the tracking management resource 182 can be configured to indicate attributes of the wireless connectivity such as the wireless network address XXXX assigned to the mobile communication device 120; network address XXX1 assigned to the wireless access point 121-1; etc. In response to receiving this information, the tracking management resource 182 updates the tracking information 113 to indicate the current attributes of the mobile communication device 120 wirelessly connecting to the wireless access point 121-1. An example of the tracking information 113 is shown in FIG. 2.

FIG. 2 is an example diagram illustrating tracking information tracking wireless connectivity provided by each of multiple wireless access points in a wireless network environment according to embodiments herein.

In this example, the tracking information 113-1 keeps track of the wireless connectivity provided by different wireless access points 121, 131, 161, etc., to different mobile communication devices in the wireless network environment 100. As previously discussed, each of the wireless access points provides further connectivity of the mobile communication devices through gateway 141 to the remote network 190.

More specifically, in this example, the tracking information 113 indicates that the wireless access point 121-1 assigned network address XXX1 supports wireless communication link 127-2 to a mobile communication device assigned network address XXAA; the tracking information 113-1 indicates that the wireless access point assigned network address YYY1 supports wireless communication link 128-1 to a mobile communication device assigned network address XXBB; and so on.

As further shown, via tracking information 113-1, the tracking information 113 is updated to indicate that new wireless services are provided by the wireless access point 121-1 (assigned network address XXX1) to the mobile communication device 120 (assigned network address XXXX) to access the remote network 190 through the gateway 141. As further discussed herein, the tracking information 113 is updated as the mobile communication device 120 connects to different wireless access points.

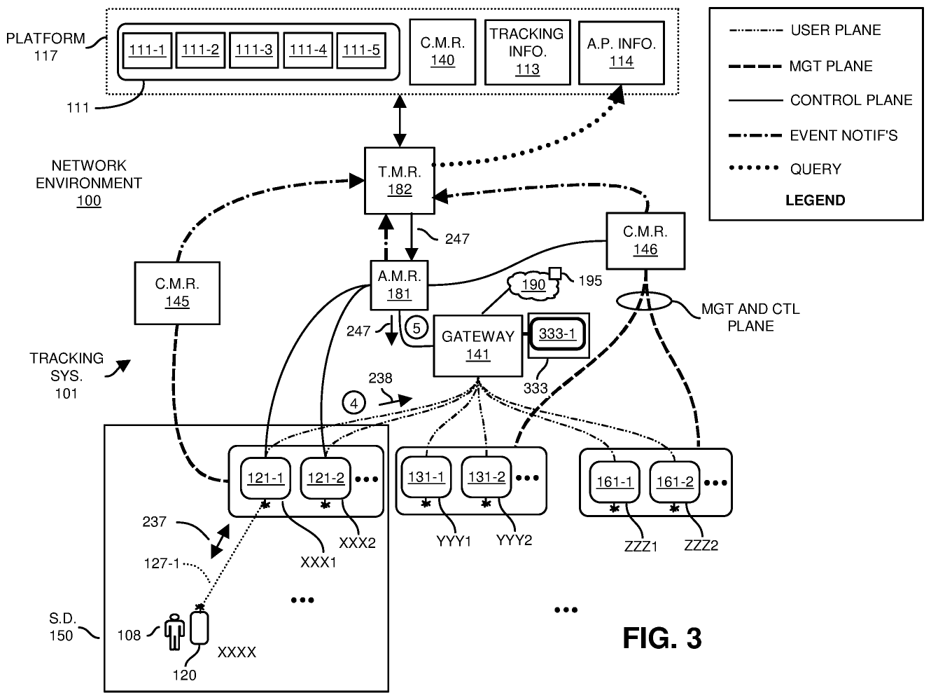

FIG. 3 is an example diagram illustrating distribution and implementation of data flow policies at a gateway to support wireless connectivity in a network environment according to embodiments herein.

As further shown, in processing operation #4,after being authenticated by the authentication management resource 181 and/or establishing the wireless communication link 127-1, the mobile communication device 120 transmits communications 237 over the wireless communication link 127-1 to the wireless access point 121-1. The wireless communications 237 can be configured to include data packets destined for delivery to one or more server resources 195 in the remote network 190.

The wireless access point 121-1 communicates the data packets via communications 238 to the gateway 141. In this example, the gateway 141 determines that it does not have a respective delivery policy (data flow control settings) assigned to the mobile communication device 120. In such an instance, the gateway 141 communicates with one or more resources in the wireless network environment 100 to determine respective flow control settings to apply to the communications 237 associated with the mobile communication device 120.

For example, the gateway 141 can be configured to request (from one or more resources such as the authentication management resource 181) what policy attributes to apply to the new user session supported by the wireless communication link 127-1. In response to receiving and forwarding the request for a data flow control settings to one or more of the authentication management resource 181, and/or the tracking management resource 182, or communication management resource 140, the gateway 141 receives data flow control settings 333-1 (such as a default data flow control policy). In one example, the communication management resource 140 or other suitable entity generates the data flow control settings 333-1 for application to the gateway 141 in response to receiving a message from the gateway 141 or other suitable entity. Note that the message (such as data flow control settings request) from the gateway 141 may include a notification of the gateway 141 receiving the communications 237 from the wireless access point 121-1.

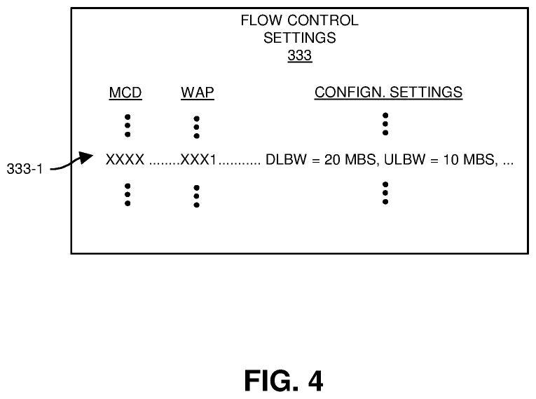

The gateway 141 then applies the received flow control settings 333-1 (see FIG. 4) to data communications 237 associated with the mobile communication device 120 between the wireless access point 121-1 and the gateway 141 (a.k.a., user plane connectivity between the wireless access point 121-1 and the gateway 141) and thus flow of communication over the wireless communication link 127-1 through gateway 141 to remote network 190.

As a more specific example, assume that the gateway 141 receives the flow control settings 333-1 (assigned to the wireless communication link 127-1 and mobile communication device 120) such as downlink bandwidth of 20 MBS (MegaBits per Second) and uplink bandwidth of 10 MBS in which to apply to data flows associated with the mobile communication device 120. In such an instance, the gateway 141 controls or limits the rate of downstream communications from remote network 190 through the gateway 141 to the wireless access point 121-1 and the mobile communication device 120 to 20 MBS; the gateway 141 controls or limits the rate of upstream communications from the mobile communication device 120 to or through the wireless access point 121-1 and the gateway 141 to remote network 190 to up to 10 MBS.

FIG. 4 is an example diagram illustrating flow control settings for application to a gateway according to embodiments herein.

In this example, in response to receiving the data flow control settings 333-1, the gateway 141 updates the data flow control settings 333 to include the data flow control settings 333-1 in which to apply to data communications associated with the mobile communication device 120.

Referring again to FIG. 3, the gateway 141 can be configured to control the flow of communications 237 (such as data packets) to and from the mobile communication device 120 based on network address information in each of the respective data packets of communications 237. For example, the communications 237 communicated from the mobile communication device 120 include the network address XXXX indicating that the communications originating from the mobile communication device 120. The wireless access point 121-1 may further include a network address XXX1 to those communication sports of the gateway 141. Accordingly, the gateway 141 is aware of the data flow to which the received communications 237 pertain.

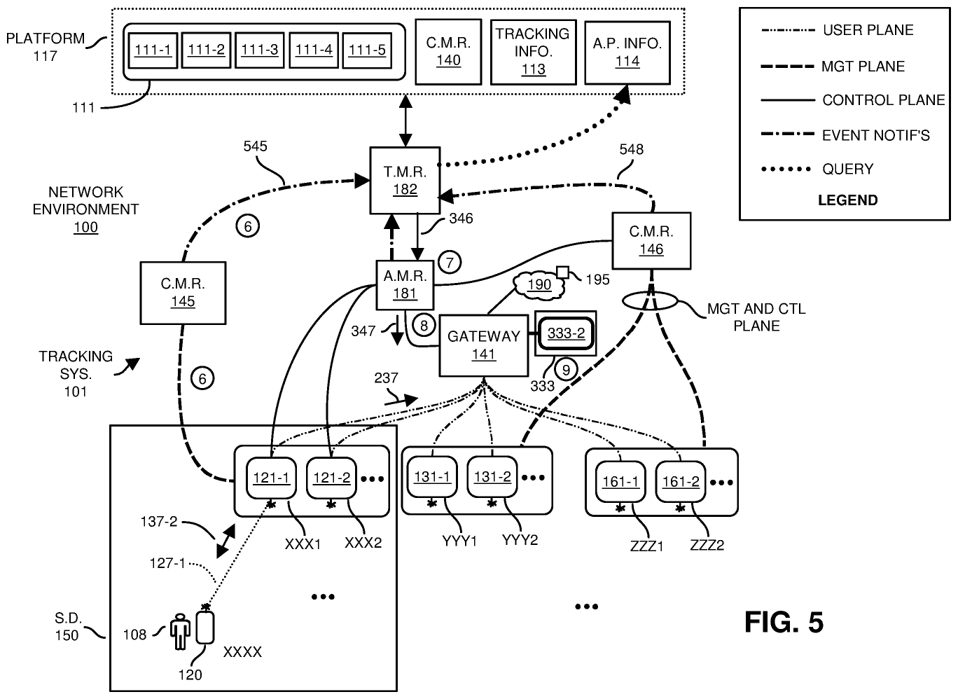

FIG. 5 is an example diagram illustrating updating of a respective data flow policy in response to a detected event and application of the updated data flow policy at a gateway according to embodiments herein.

In further examples, the communication management resource 145 (such as management network device) supports management plane functions associated with operation of the wireless access points 121 in the subscriber domain 150. More specifically, the communication management resource 145 can be configured as an element of the tracking system 101 that provides one or more operations such as configuring, monitoring, and providing management, monitoring and configuration services, etc., to one or more layers of the network stack and other parts of the tracking system 100.

As further shown, the communication management resource 145 can be configured to monitor data flow conditions associated with the wireless access points 121 in the subscriber domain 150.

For example, in processing operation #6,assume that the communication management resource 145 monitors attributes such as including the data flow rate of communications through each of the wireless access points 121. The communication management resource 145 forwards any event notifications associated with operating conditions of the wireless access points 121 to the tracking management resource 182, which further updates the access point information 114 based on the received notifications.

Thus, based on feedback from the first wireless access point 121-1 another wireless access points, the communication management resource 145 receives information associated with the wireless access points and/or information indicating a quality of service associated with the data flows of mobile communication device 121-1 supported by the wireless access point 121-1. Via communications 545, the communication management resource 145 notifies the tracking management resource 182 of the monitored operating conditions of the wireless access points such as quality of service provided by the wireless access point 121-1 to the mobile communication device 120. The tracking management resource 182 updates the access point information 114 based on the received communications 545.

Note that the examples of notifications from the communication management resource 145 to the tracking management resource 182 can include any notifications of operating conditions of the wireless access points 121 such as an amount of clients attached to the wireless access point 121-1, detected levels of co-channel interference associated with wireless communication link 127-1 associated with wireless access point 121-1; detection of airtime conditions associated with the wireless communication link 127-1 supporting wireless connectivity to each of multiple mobile communication devices in subscriber domain 150, amount of congestion associated with a corresponding CPU in the wireless access point 121-1 supporting data flow, amount of memory utilization in the wireless access point 121-1 potentially inhibiting traffic flow, health status router information associated with the wireless access point 121-1, unstable/stable wireline network backhaul conditions associated with the connectivity between the wireless access point 121-1 and the gateway 141, etc.

Any of the above monitored conditions by the communication management resource 145 may be favorable or unfavorable to supporting wireless connectivity between one or more of the wireless access points 121 and corresponding communication devices.

In further example embodiments, the tracking management resource 182 or other suitable entity updates the access point information 114 based upon the received notifications from the communication management resource 145. The access point information 114 thus keeps track of the current operating conditions associated with each of the wireless access points 121 via the access point information 114 (such as an access point capability database).

As previously discussed, it is desirable to provide the mobile communication device 120 an appropriate level of service to which the mobile communication device subscribes. However, in certain instances, one or more of the wireless access points 121 may experience unfavorable operating conditions potentially preventing the one or more wireless access point from providing a desired level of service (such as bandwidth, latency, etc.). Assume that the wireless access point 121-1 experiences one or more unfavorable operating conditions such as: a high amount of clients attached to the wireless access point 121-1, high detected levels of co-channel interference associated with wireless communication link 127-1 and with wireless access point 121-1; detection of low airtime conditions associated with the wireless communication link 127-1 supporting wireless connectivity to each of multiple mobile communication devices in subscriber domain 150, high amount of congestion associated with a corresponding CPU in the wireless access point 121-1 inhibiting traffic flow, high amount of memory utilization in the wireless access point 121-1 inhibiting traffic flow through the wireless access point 121-1, poor router health status associated with the wireless access point 121-1, unstable wireline network backhaul conditions associated with the connectivity between the wireless access point 121-1 and the gateway 141, etc.

In such an instance, the tracking management resource 182 stores the one or more unfavorable conditions associated with the wireless access point 121-1 in the access point information 114. As previously discussed, the communication management resource 140 can be configured to use the tracking information 113 as well as corresponding access point information 114 to dynamically adjust the data flow control settings associated with each of the mobile communication devices depending upon the current operating conditions.

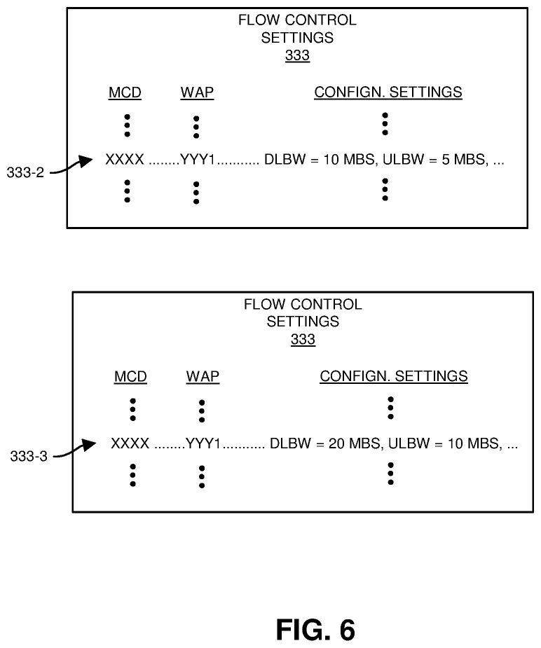

More specifically, in view of unfavorable operating conditions as captured by the access point information 114, the communication management resource 140 can be configured to adjust the data flow control settings associated with the mobile communication device 120. For example, in response to detecting one or more of the unfavorable conditions as captured by the access point information 114 as previously discussed, the communication management resource 140 updates corresponding data flow control settings 333-1 associated with the gateway 141 providing throughput for the mobile communication device 120. In this example embodiment, the mobile communication device 120 was provided in uplink bandwidth of 10 MBS and downlink bandwidth of 20 MBS during favorable conditions. In view of the detected one or more unfavorable operating conditions, the communication management resource 140 can be configured to reduce allocation of wireless bandwidth to the mobile communication device 120. For example, the communication management resource 140 produces updated flow control settings 333-2 (see FIG. 6) to indicate downlink bandwidth of 10 MBS assigned to the mobile communication device 120 and uplink bandwidth of 5 MBS to the mobile communication device 120. Thus, via the newly generated data flow control settings 333-2, the communication management resource 140 reduces the downlink bandwidth from 20 MBS to 10 MBS; the communication management resource 140 thus reduces the uplink bandwidth from 10 MBS to 5 MBS.

In processing operation #7, via communications 346, the communication management resource 140 or tracking management resource 182 communicates the updated data flow configuration settings 333-2 to the authentication management resource 181. As further shown, via communications 347 in processing operation #8, the authentication management resource 181 forwards the updated data flow configuration settings 333-2 to the gateway 141 in view of the unfavorable operating conditions associated with the mobile communication device 120.

In processing operation #9, the gateway 141 applies the new data flow configuration settings 333-2 to the communications 237 associated with the mobile communication device 120. In other words, in accordance with application of the updated data flow control settings 333-2, the gateway 141 controls the downlink bandwidth associated with communications from the gateway 141 through the wireless access point 121-1 to the mobile communication device 120 to be 10 MBS instead of 20 MBS; the gateway 141 controls the uplink bandwidth associated with communications from the mobile communication device 120 through the wireless access point 121-1 to the gateway 141 to be 5 MBS instead of 10 MBS.

In still further example embodiments, as previously discussed, it is desirable to provide the mobile communication device 120 an appropriate level of service to which the mobile communication device subscribes during favorable operating conditions. To this end, the communication management resource 140 can be configured to retrieve information indicating a respective quality of service to provide to the mobile communication device 120 assigned network address XXXX. The communication management resource 140 then compares the determined quality of service associated with the current data flow settings 333-2 to a threshold service level (such as 10 MBS uplink and 20 MBS downlink) to which a user of the mobile communication device subscribes. Assuming that appropriate network resources are available to support the threshold service level, the communication management resource 140 can be configured to adjust the data flow control settings 333 applied to the gateway 141 on an as needed basis to support the threshold service level to the mobile communication device 120.

More specifically, assume that the one or more of the wireless access points 121 now experiences more favorable operating conditions. For example, assume that the wireless access point 121-1 experiences more favorable operating conditions such as one or more of: a lower amount of clients attached to the wireless access point 121-1, lower detected levels of co-channel interference associated with wireless communication link 127-1 and with wireless access point 121-1; detection of high airtime conditions associated with the wireless communication link 127-1 supporting wireless connectivity to each of multiple mobile communication devices in subscriber domain 150, lower amount of congestion associated with a corresponding CPU in the wireless access point 121-1 inhibiting traffic flow, lower amount of memory utilization in the wireless access point 121-1 no longer inhibiting traffic flow through the wireless access point 121-1, better router health status associated with the wireless access point 121-1, stable wireline network backhaul conditions associated with the connectivity between the wireless access point 121-1 and the gateway 141, etc.

In such an instance, the tracking management resource 182 or other suitable entity receives this improved network condition information associated with the wireless access points 121 (such as via communications 545) and stores it in the access point information 114 in a similar manner as previously discussed. As previously discussed, the communication management resource 140 can be configured to dynamically adjust the data flow control settings associated with each of the mobile communication devices depending upon the current operating conditions.

In view of the recent favorable or improved operating conditions as captured by the access point information 114 (and feedback from the wireless access points 120 and/or communication management resource 145), the communication management resource 140 can be configured to adjust the data flow control settings associated with the mobile communication device 120 to accommodate the threshold level of subscriber service (such as 10 MBS uplink and 20 MBS downlink) that should be provided to the mobile communication device 120 during favorable conditions. For example, in response to detecting the now more favorable conditions as captured by the access point information 114, and determining that the wireless access point can provide such global service, the communication management resource 140 updates corresponding data flow control settings 333-3 (see FIG. 6) associated with the gateway 141 providing throughput for the mobile communication device 120. In this example embodiment, in view of the detected one or more favorable operating conditions, the communication management resource 140 increases allocation of wireless bandwidth to the mobile communication device 120. For example, the communication management resource 140 produces updated flow control settings 333-3 (see FIG. 6) to indicate downlink bandwidth of 20 MBS assigned to the mobile communication device 120 and uplink bandwidth of 10 MBS to the mobile communication device 120. Thus, via the newly generated data flow control settings 333-3, the communication management resource 140 increases the downlink bandwidth from 10 MBS to 20 MBS; the communication management resource 140 thus increases the uplink bandwidth from 5 MBS to 10 MBS.

In processing operation #7, via communications 346, the communication management resource 140 communicates the updated data flow configuration settings 333-3 to the authentication management resource 181. As further shown, via communications 347, the authentication management resource 181 forwards the updated data flow configuration settings 333-3 to the gateway 141.

In processing operation #9, the gateway 141 applies the new data flow configuration settings 333-3 to the communications 237 associated with the mobile communication device 120. In other words, in accordance with the updated data flow control settings 333-3, the gateway 141 controls the downlink bandwidth associated with communications from the gateway 141 through the wireless access point 121-1 to the mobile communication device 120 to be 20 MBS instead of 10 MBS; the gateway 141 controls the uplink bandwidth associated with communications from the mobile communication device 120 through the wireless access point 121-1 to the gateway 141 to be 10 MBS instead of 5 MBS. Thus, the mobile communication device 120 and corresponding user 108 are provided the subscriber level of service.

In a similar manner that communication management resource 145 provides operating condition feedback associated with wireless access points 121, the communication management resource 146 monitors operating conditions associated with wireless access points 131 and 161 and provides corresponding notifications of same to the tracking management resource 182 for storage in access point information 114.

In a similar manner, the tracking system 101 tracks locations of each of the mobile communication devices connected to the different wireless access points, monitors corresponding operating conditions of those wireless access points, and dynamically adjusts the corresponding data flow control settings provided to the mobile communication devices through the gateway 141 depending upon whether the monitored operating conditions of the wireless access points providing wireless service are favorable or unfavorable.

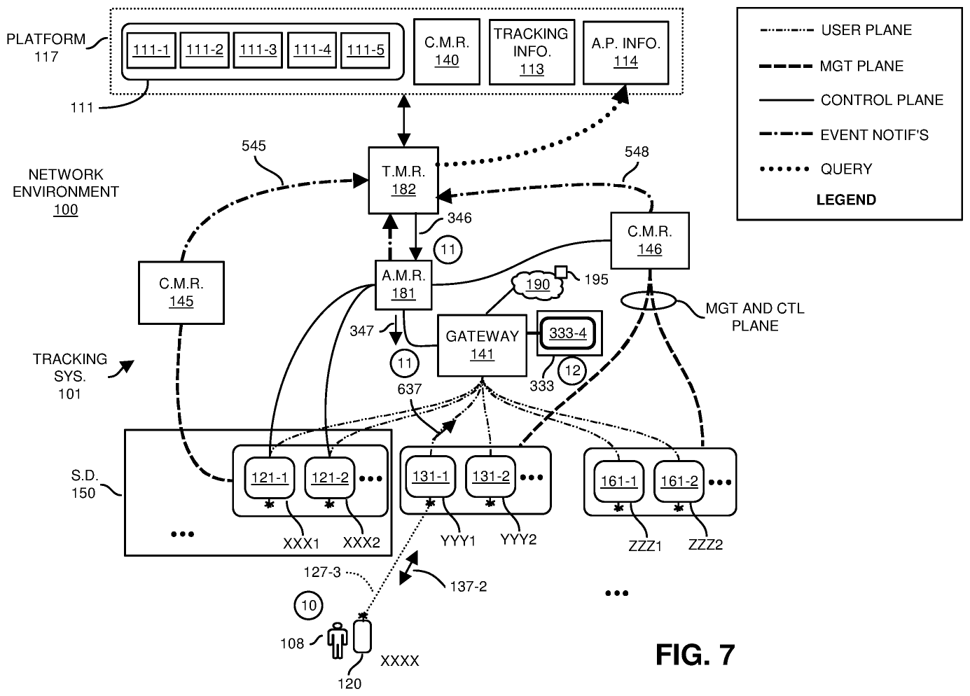

FIG. 7 is an example diagram illustrating a handoff of a communication device to from a first wireless access point in a subscriber domain to a second wireless access point disposed outside of the subscriber domain and application of data flow control settings according to embodiments herein.

As previously discussed, the one or more resources of the tracking system 101 such as tracking management resource 182, communication management resource 140, etc., can be configured to track movement of the mobile communication device 120 through the wireless network environment 100 based upon detected connectivity of the mobile communication device 120 with any of the multiple wireless access points 121, 131, 161, etc.

In one configuration of the tracking system 101, the movement of the mobile communication device 120 is tracked based on detected handoffs of the mobile communication device 120 from one wireless access point 121-1 to another wireless access point 131-1 in the wireless network environment. In other words, the communication management resource 140 can be configured to determine a corresponding location of the mobile communication device 120 based upon which of multiple wireless access points the mobile communication device 120 is connected based upon the access point information 114 indicating same.

For example, assume that the mobile communication device 120 moves out of wireless communication range with respect to the one or more wireless access points 121 in the subscriber domain 150. In such an instance, in processing operation #10, the mobile communication device 121 performs a handoff from the wireless access point 121-1 to the wireless access point 131-1 as shown in FIG. 7.

The communication management resource 146 or other suitable entity detects the handoff of the mobile communication device 120 from the wireless access point 121-1 to the wireless access point 131-1. One or more of the tracking management resource 182, communication management resource 146, etc., continuously updates the tracking information 113 to indicate the current wireless access point to which the mobile communication device 120 is connected via a corresponding wireless communication link.

In a similar manner that communication management resource 145 provides operating conditions such as feedback associated with wireless access points 121, the communication management resource 146 can be configured to monitor operating conditions in wireless services associated with wireless access points 131 and 161 and provide corresponding notifications of same to the tracking management resource 182 for storage in access point information 114. The communication management resource 146 monitors operating conditions of the different wireless access points 131 and wireless access points 161 and forwards such information for storage in the access point information 114. Thus, the access point information 114 is continuously updated to indicate current operating conditions of each of the different sets of wireless access points.

As further discussed herein, the communication management resource 140 further performs operations of: monitoring operating conditions of each of the multiple wireless access points providing wireless services; and updates respective data flow control settings applied to the gateway 141 based on the operating conditions of a respective wireless access point to which the mobile communication device 120 is wirelessly connected.

Additionally, the communication management resource 140 detects, via tracking information 113, movement of each of the mobile communication devices connecting to a new wireless access point. In response to the movement and/or handoff, the communication management resource 140 can be configured to generate and/or update data flow control settings associated with a handed off or moved mobile communication device 120 and forwards such control settings to the gateway 141 for control of the data flows associated with the corresponding mobile communication device to which the data flow control settings pertain.

As a more specific example, each of the wireless access points 121, 131, and 161 are coupled to the gateway 141 via a shared communication link. As previously discussed, the shared communication link supports data flows (i.e., flow of data packets) associated with different mobile communication devices over the shared communication link between the wireless access points and the gateway 141. The different data flows managed by the gateway 141 are defined by the network address of the wireless access point and the mobile communication device to which corresponding data packets pertain.

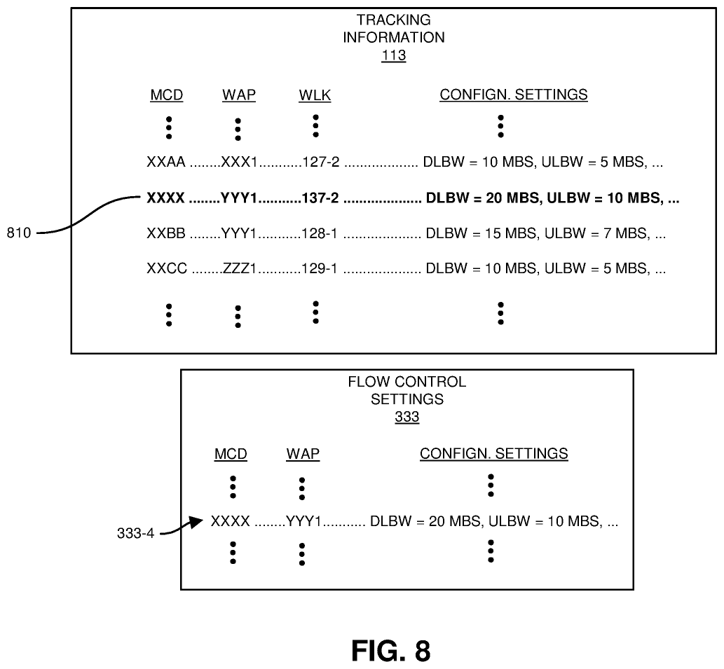

The communication management resource 140 detects the handoff of the mobile communication device 120 from the first wireless access point 121-1 to the second wireless access point 131-1. As previously discussed, the tracking information 113 is updated in any suitable manner based upon the handoff. For example, the communication management resource 146 can be configured to detect the handoff and provide notification that the mobile communication device 120 is now connected to the wireless access point 131-1. This information is then used to update the tracking information 113. Alternatively, the wireless access point 131-1 receiving the handoff of the mobile communication device 120 can be configured to communicate with the authentication management resource 181 which provides notification to tracking management resource 182 of the handoff. The tracking management resource 182 updates the tracking information 113 to indicate the handoff of the mobile communication device 120 from the wireless access point 121-1 to the wireless access point 131-1. The tracking information 113-2 in FIG. 8 indicates the movement of the mobile communication device 120 via entry of tracking information 810. For example, the updated tracking information 810 indicates that the mobile communication device 120 assigned network address XXXX is connected to the wireless access point 131-1 assigned network address YYY1 via the corresponding new wireless communication link 137-2. If desired, the tracking information 113 and updated tracking information 810 further indicates an appropriate level wireless service to provide the mobile communication device 120.

In a similar manner as previously discussed, the communication management resource 146 (via management plane connectivity to the wireless access points 131, 161) determines the above-referenced operating conditions associated with each of the wireless access points and communicates them to the tracking management resource 182 for storage in access point information 114. For example, the communication management resource 146 monitors operating conditions of the second wireless access point 131-1 through which the mobile communication device 120 communicates with and through the gateway 141. In a similar manner as previously discussed, a combination of the gateway 141 and the second wireless access point 131-1 support a second session of data flows between the mobile communication device 120 and the remote network 190.

In processing operation #11, based on the current operating conditions of the second wireless access point 131-1 as indicated by the access point information 114, the communication management resource 140 dynamically generates second settings to control the second session of data flows between the mobile communication device 120 and the remote network 190 based on the new wireless communication link 137-2. In processing operation #12, the gateway 141 receives the updated data flow control settings 333-4 associated with the mobile communication device (see FIG. 8). As previously discussed, the communication management resource 140 generates the data flow control settings 333-4 based on detecting movement of the mobile clinic case and device 120. The gateway 141 uses the data flow control settings 333-4 to control communications associated with the second session of data flows between the mobile communication device 120 and the remote network 190.

Further, in a similar manner as previously discussed, the communication management resource 146 monitors operating conditions associated with each of the wireless access points 131, wireless access points 161, etc. the monitored operating conditions can include an amount of clients attached to the wireless access point 131-1, detected levels of co-channel interference associated with wireless communication link 137-2 associated with wireless access point 131-1; detection of airtime conditions associated with the wireless communication link 137-2 supporting wireless connectivity to each of multiple mobile communication devices outside of subscriber domain 150, amount of congestion associated with a corresponding CPU in the wireless access point 131-1 supporting traffic flow, amount of memory utilization in the wireless access point 131-1 potentially inhibiting traffic flow, health status router associated with the wireless access point 131-1, unstable/stable wireline network backhaul conditions associated with the connectivity between the wireless access point 131-1 and the gateway 141, etc. Any of the above conditions may be favorable or unfavorable to supporting wireless connectivity between one or more of the wireless access points 121 and corresponding communication devices.

As operating conditions of the wireless access points change over time, the communication management resource 140 updates the data flow control settings applied by the gateway 141 to corresponding data flows associated with the different mobile communication devices. Accordingly, the communication management functions as described herein provide location tracking of the different mobile communication devices and updating of corresponding flow control settings associated with the gateway depending on corresponding operating conditions of the network.

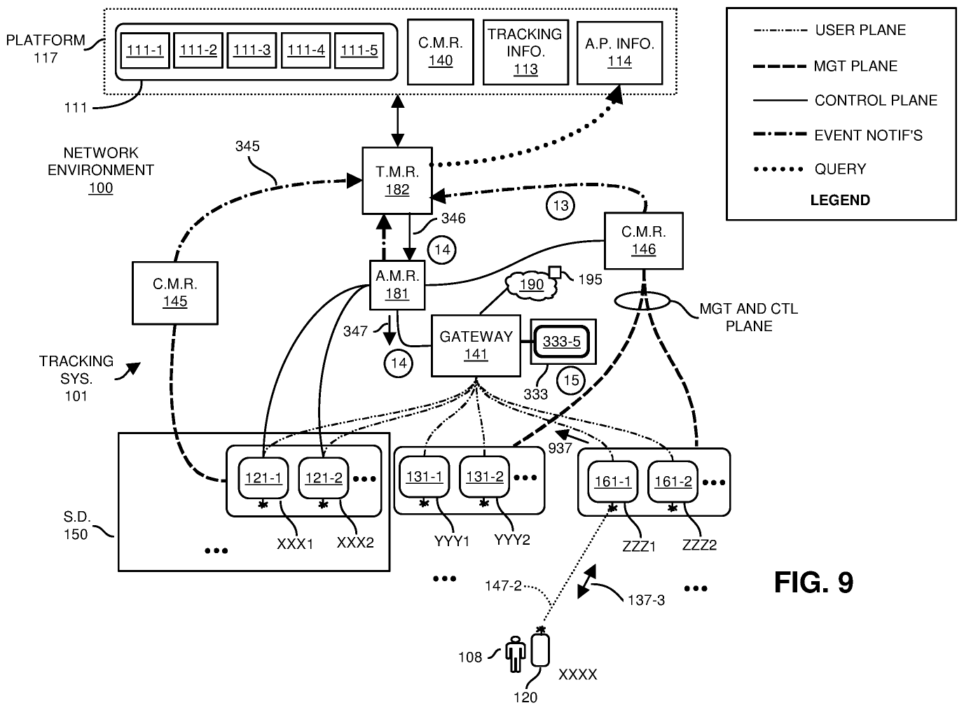

FIG. 9 is an example diagram illustrating a handoff of a communication device from the second wireless access point to a third wireless access point disposed outside of a subscriber domain application and application of data flow control settings according to embodiments herein.

In this example embodiment, assume that the mobile communication device 120 moves out of range with respect to the one or more wireless access points 131 (operated by the same wireless network service provider that operates the wireless access points 121). In other words, the wireless access points 161 are operated by a second wireless network service provider. In such an instance, in processing operation #13, the mobile communication device 120 performs a handoff from the wireless access point 131-1 to the wireless access point 161-1 as shown in FIG. 9.

The communication management resource 146 or other suitable entity detects the handoff of the mobile communication device 120 from the wireless access point 131-1 to the wireless access point 161-1. In a similar manner that communication management resource 145 provides operating conditions such as feedback associated with wireless access points 121, the communication management resource 146 monitors operating conditions associated with wireless access points 161 and provides corresponding notifications of same (such as usage of the wireless access points) to the tracking management resource 182 for storage in tracking information 113.

The communication management resource 140 detects, via tracking information 113, movement of each of the mobile communication devices connecting to a new wireless access point. In response to the movement and/or handoff of the mobile communication device 120 from the wireless access point 131-1 to the wireless access point 161-1, in processing operation #14, the communication management resource 140 generates and/or updates data flow control settings associated with a handed off or moved mobile communication device 120 and forwards such control settings to the gateway 141 for control of the data flows associated with the corresponding mobile communication device to which the data flow control settings pertain.

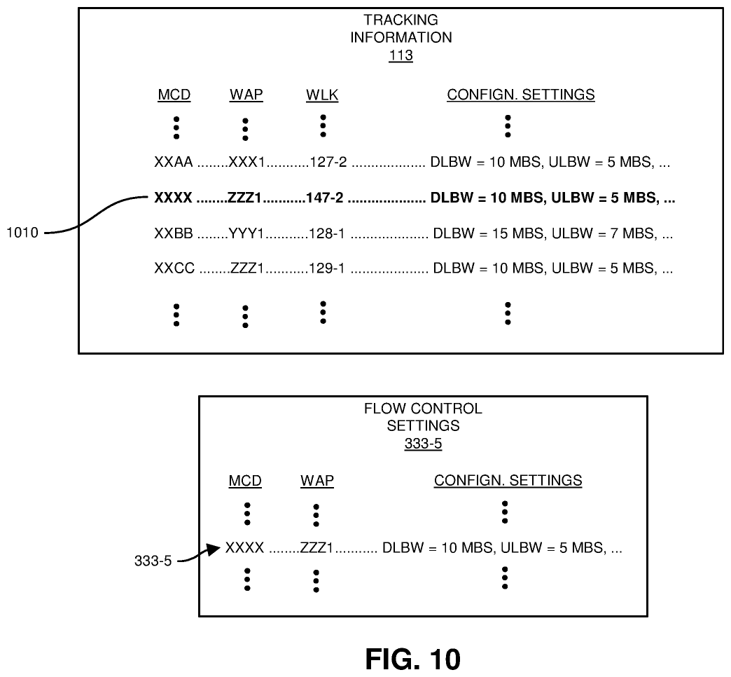

More specifically, assume that the tracking management resource 182 updates the tracking information 113 to indicate the handoff of the mobile communication device 120 from the wireless access point 131-1 to the wireless access point 161-1. The tracking information 113 and corresponding new entry of tracking information 1010 associated with the handoff in FIG. 10 indicates the movement of the mobile communication device 120. The updated tracking information 1010 indicates that the mobile communication device 120 (assigned network address XXXX) is connected to the wireless access point 161-1 (assigned network address ZZZ1) via the corresponding wireless communication link 147-2. If desired, the tracking information 113 can be configured to further indicate an appropriate level of wireless service to provide the mobile communication device 120 as determined by the communication management resource 140 or other suitable entity.

Note that the mobile communication device 120 corresponding user 108 may be afforded only a lower quality of service when using wireless access points and/or wireless services provided by the second wireless network service provider. This condition may prompt the communication management resource 140 to adjust the data flow control settings to be applied to the communications 937 associated with the mobile communication device 120 communicated from the mobile communication device 120 through the wireless access point 161-1 and gateway 141 to the remote network 190.

In a similar manner as previously discussed, the communication management resource 146 (via management plane connectivity to the wireless access points 131, 161) determines the above-referenced operating conditions associated with each of the wireless access points and communicates them to the tracking management resource 182 for storage in access point information 114.

Further, in a similar manner as previously discussed, the communication management resource 146 monitors operating conditions associated with each of the wireless access points 161. As operating conditions of the different wireless access points changes over time, the communication management resource 140 updates the data flow control settings applied by the gateway 141 to corresponding data flows associated with the different mobile communication devices. In addition to uplink and downlink bandwidth the data flow control settings can indicate data flow control based on time of day, content filtering, etc., in which to apply to the corresponding data flows associated with the mobile communication device 120.

Accordingly, the communication management functions as described herein provide location tracking of the different mobile communication devices and update of corresponding flow control settings associated with the gateway 141 depending on corresponding operating conditions of the network. More specifically, in a similar manner, the communication management resources (such as one or more of authentication management resource 181, tracking management resource 182, communication management resource 140, communication management resource 145, communication management resource 146, etc.) collectively operate to track each of multiple mobile communication devices in wireless communication with multiple wireless access points 121, 131, 161, etc. Each of the wireless access points is in communication with a gateway 141 that controls connectivity of the mobile communication devices to a remote network 190. The communication management resource 140 or other suitable entity dynamically generates control settings to control data flows of each of the multiple mobile communication devices through the gateway 141 such as based on monitored operating conditions of the wireless access points and/or wireless service levels subscribed by the different users operating the mobile communication devices. The communication management resource 140 provides the control settings for each of the mobile communication devices to the gateway 140 to control the data flows of the multiple mobile communication devices to the remote network 190. During favorable operating conditions, the gateway 141 provides subscribed wireless service levels to the communication devices. However, during unfavorable operating conditions of the wireless access points or other entities in the network environment, the gateway 141 provides reduced wireless service levels to the communication devices.

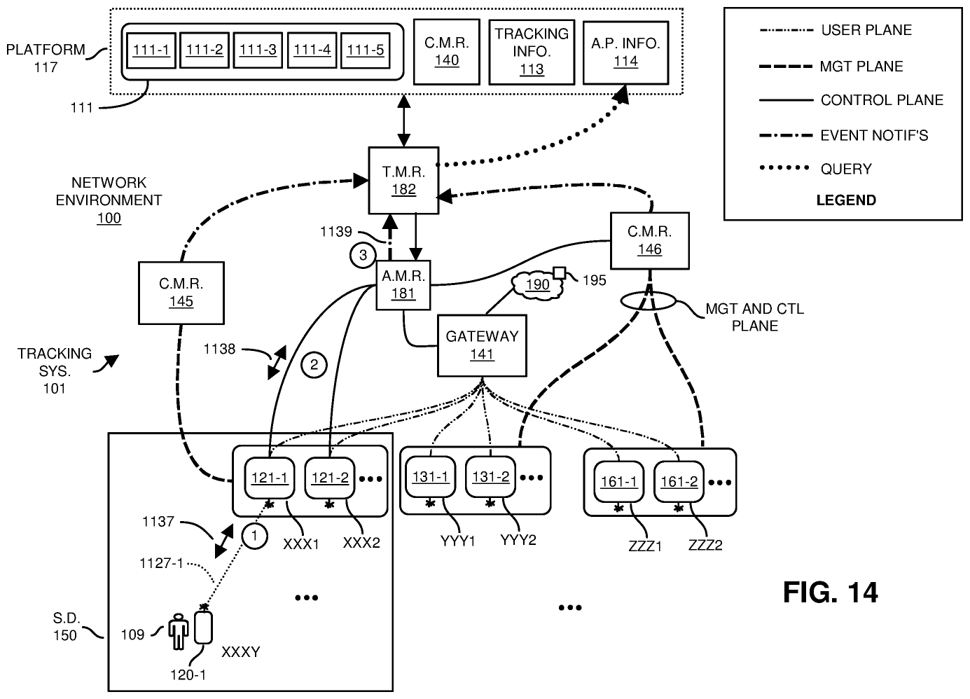

FIG. 14 is an example diagram illustrating a wireless network environment and tracking of communication devices to provide wireless services according to embodiments herein.

As previously discussed, in one implementation, the tracking system 101 (such as including communication management resource 140) monitors operating conditions of the multiple sets of wireless access points 121, 131, 161, etc. For example, the tracking system 101 monitors operating conditions of a first wireless access point 121-1 through which a mobile communication device 120 communicates with a gateway 141 (such as wireless access gateway that controls a rate of wireless communications over wireless communication link 127-1). The monitored operating conditions include feedback from the wireless access points or other suitable entities regarding the ability of those wireless access points to support communications between the mobile communication devices and the gateway 141. The combination of gateway 141 and the first wireless access point 121 support one or more sessions of data flows between the mobile communication device through the gateway 121 to a remote network 190 (such as the Internet or other network). Based on the monitored operating conditions of the wireless access point 121, the controller (communication management resource 140 or other suitable entity) associated with the tracking system 101 dynamically generates control settings to control the session of data flows through the gateway 141. Control of the data flows associated with different data flows through the gateway 141 may also control the flow of communications through the respective wireless access points.

As a more specific example, the controller (a.k.a., communication management resource 140) can be configured to apply the control settings to the gateway 141 on a per device basis to control communications associated with the session of data flows between a respective mobile communication device (such as 120, 120-1, etc.) and the remote network 190. The gateway 141 can be configured to control communications in either direction such as in an uplink from the respective mobile communication device through the first wireless access point 121-1 and the gateway 141 to the remote network 190. Additionally, the gateway 141 can be configured to control downlink communications from the remote network 190 through the gateway 141 and the first wireless access point 121-1 to the respective mobile communication device.

As further discussed herein, the controller applies different control settings under different operating conditions and/or as the mobile communication device uses different wireless access points to communicate through the gateway to the remote network.

Initially, in processing operation #1 of FIG. 14, assume that the user 109 operates the mobile communication device 120-1 to establish the wireless communication link 1127-1 with the wireless access point 121-1 disposed in the subscriber domain 150. The wireless communication link 1127-1 supports communications 1137 between the mobile communication device 120 and the wireless access point 121-1.

In one example, prior to providing the mobile communication device 120-1 and corresponding user 109 access to the remote network 190 through the gateway 141, the wireless access point 121-1 must first authenticate the user 109 and/or corresponding communication device 120-1 (assigned network address XXXY) to use wireless services provided by the first wireless network service provider operating the wireless access points 121.

Note again that each of the wireless access points 121, 131, 161, etc., can be configured to support any suitable one or more wireless communication protocols. For example, the one or more wireless access points in wireless network environment 100 can be configured to support Wi-Fi™, LTE (Long Term Evolution) communications, 4G communications, 5G communications, and so on.

As further shown, in processing operation #2 of FIG. 14, the wireless access point 121-1 supports authentication of the mobile communication device 120-1 and/or corresponding user 109. For example, the mobile communication device 120-1 and/or corresponding wireless access point 121-1 generate an authentication request to use wireless services associated with the wireless access point 121-1. Via communications 1138, the wireless access point 121-1 forwards an authentication request associated with authentication of the mobile communication device 120-1 from the wireless access point 121-1 to the authentication management resource 181.

Note that authentication of the mobile communication device 120-1 and/or corresponding user 109 can be implemented in any suitable manner. For example, in one embodiment, in response to receiving the authentication request associated with the mobile communication device 120-1, via communications from the authentication management resource 181 through the wireless access point 121-1 to the mobile communication device 120-1, the authentication management resource 181 requests that the mobile communication device 120-1 provide appropriate authentication credentials to the authentication management resource 181. Via communications 1137 and communications 1138, the authentication management resource 181 receives authentication credentials from the mobile communication device 120-1. The authentication management resource 181 verifies that the user 108 and corresponding mobile communication device 120-1 are authorized to use the gateway 141 and corresponding wireless access point 121-1. For example, based on the supplied authentication credentials, the authentication management resource 181 determines that the mobile communication device 120-1 assigned network address XXXY and corresponding user 108 are authorized to use the wireless services provided by the wireless access point 121-1.

As further shown, in processing operation #3, via communications 1139, the authentication management resource 181 forwards notification of the established and authorized wireless communication link 1127-1 and corresponding attributes of the mobile communication device 120-1 to the tracking management resource 182. For example, the notification in communications 1139 to the tracking management resource 182 can be configured to indicate attributes of the wireless connectivity such as the wireless network address XXXY assigned to the mobile communication device 120-1, network address XXX1 assigned to the wireless access point 121-1, etc. In response to receiving this information, the tracking management resource 182 updates the tracking information 113 to indicate the current attributes of the mobile communication device 120-1 wirelessly connecting to the wireless access point 121-1 via wireless communication link 1127-1. In other words, via this information, the tracking system 101 tracks the connectivity of the mobile communication device 120-1 to the wireless access point 121-1 and corresponding network of resources including gateway 141, network 190, etc. An example of the tracking information 113 is shown in FIG. 2.

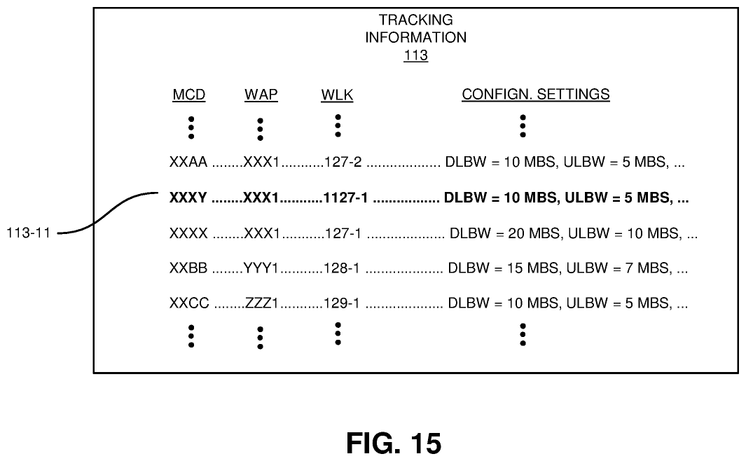

FIG. 15 is an example diagram illustrating tracking information tracking wireless connectivity provided by each of multiple wireless access points in a wireless network environment according to embodiments herein.

In this example, the tracking information 113 keeps track of the wireless connectivity provided by different wireless access points 121, 131, 161, etc., to different mobile communication devices in the wireless network environment 100. As previously discussed, each of the wireless access points provides further connectivity of the mobile communication devices through gateway 141 to the remote network 190.

More specifically, in this example, the tracking information 113 indicates that the wireless access point 121-1 assigned network address XXX1 supports wireless communication link 127-2 to a mobile communication device assigned network address XXAA; the tracking information 113 indicates that the wireless access point 121-1 assigned network address XXX1 supports wireless communication link 1127-1 to a mobile communication device assigned network address XXXY; the tracking information 113 indicates that the wireless access point 121-1 assigned network address XXX1 supports wireless communication link 127-1 to a mobile communication device assigned network address XXXX; the tracking information 113 indicates that the wireless access point assigned network address YYY1 supports wireless communication link 128-1 to a mobile communication device assigned network address XXBB; and so on.

As further shown, via tracking information 113-11, based on new wireless communication link 1127-1, the tracking information 113 is updated to include tracking information 113-11 indicating that new wireless services are provided by the wireless access point 121-1 (assigned network address XXX1) to the mobile communication device 120-1 (assigned network address XXXY) to access the remote network 190 through the gateway 141. As further discussed herein, the tracking information 113 is updated as the mobile communication device 120-1 connects to different wireless access points. In this example embodiment, the tracking information 113 indicates that the mobile communication device 120-1 (network address XXXY) is assigned use of configuration settings supporting downlink bandwidth of 10 MBS and uplink bandwidth of 5 MBS.

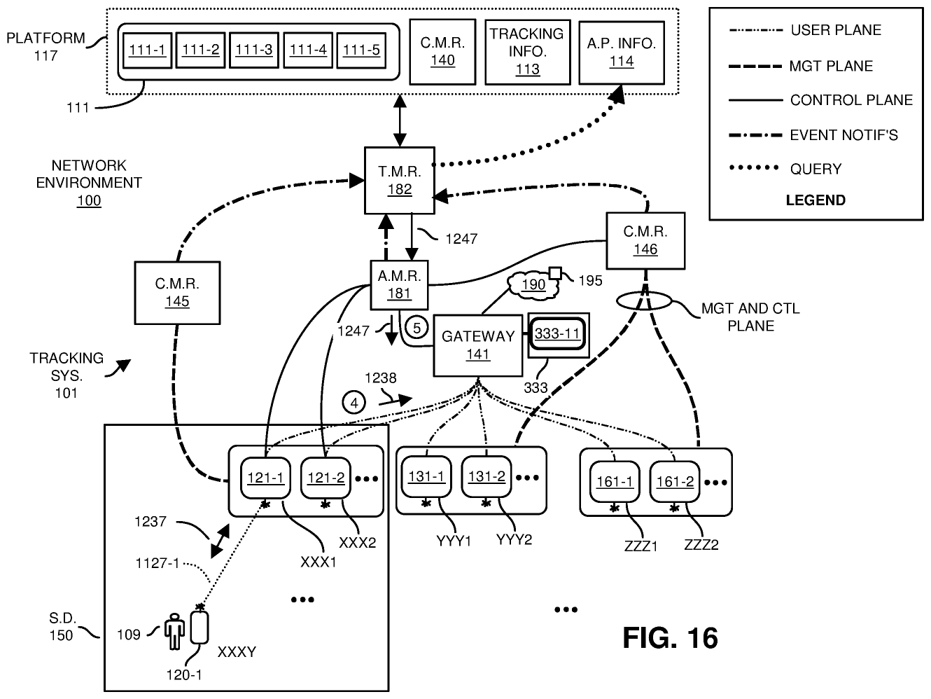

FIG. 16 is an example diagram illustrating distribution and implementation of data flow policies at a gateway to support wireless connectivity in a network environment according to embodiments herein.

As further shown, in processing operation #4 of FIG. 16, after being authenticated by the authentication management resource 181 and/or establishing the wireless communication link 1127-1, the mobile communication device 120-1 transmits communications 1237 over the wireless communication link 1127-1 to the wireless access point 121-1. The wireless communications 1237 can be configured to include data packets destined for delivery to one or more server resources 195 in the remote network 190.

The wireless access point 121-1 communicates the data packets via communications 1238 to the gateway 141. In this example, the gateway 141 determines that it does not yet have a respective delivery policy (data flow control settings) assigned to the mobile communication device 120-1 (network address XXXY). In such an instance, the gateway 141 communicates with one or more resources in the wireless network environment 100 to determine respective flow control settings to apply to the communications 1237 and communications 1238 associated with the mobile communication device 120.

For example, the gateway 141 can be configured to request (from one or more resources such as the authentication management resource 181) what policy attributes to apply to the new user data flow session supported by the wireless communication link 1127-1. In response to receiving and forwarding the request for a data flow control setting to one or more of the authentication management resource 181, and/or the tracking management resource 182, or communication management resource 140, the gateway 141 receives data flow control settings 333-11 (such as a default data flow control policy). In one example, the communication management resource 140 or other suitable entity generates the data flow control settings 333-11 for application to the gateway 141 in response to receiving a message from the gateway 141 or other suitable entity. Note that the message (such as data flow control settings request) from the gateway 141 may include a notification of the gateway 141 receiving the communications 1237 (associated with the mobile communication device 120-1) from the wireless access point 121-1.

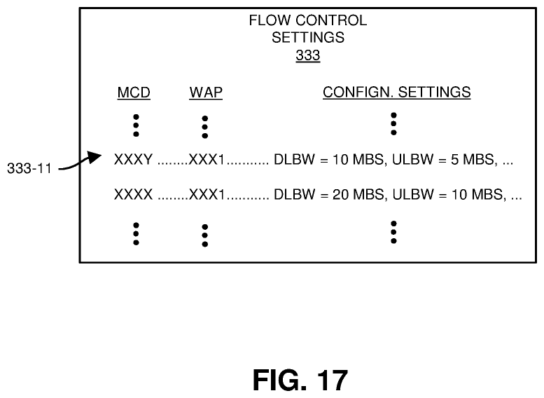

The gateway 141 then applies the received flow control settings 333-11 (see FIG. 17) to data communications 1237 and communications 1238 associated with the mobile communication device 120-1 between the wireless access point 121-1 and the gateway 141 (a.k.a., user plane connectivity between the wireless access point 121-1 and the gateway 141) and thus flow of communication over the wireless communication link 1127-1 through gateway 141 to remote network 190.

As a more specific example, assume that the gateway 141 receives the flow control settings 333-11 (assigned to the wireless communication link 1127-1 and mobile communication device 120-1) such as downlink bandwidth of 10 MBS (MegaBits per Second) and uplink bandwidth of 5 MBS in which to apply to data flows associated with the mobile communication device 120-1. In such an instance, the gateway 141 controls or limits the rate of downstream communications from remote network 190 through the gateway 141 to the wireless access point 121-1 and the mobile communication device 120-1 to 10 MBS; the gateway 141 controls or limits the rate of upstream communications from the mobile communication device 120-1 to or through the wireless access point 121-1 and the gateway 141 to remote network 190 to up to 5 MBS.

FIG. 17 is an example diagram illustrating flow control settings for application to a gateway according to embodiments herein.

In this example, in response to receiving the data flow control settings 333-11, the gateway 141 updates the data flow control settings 333 to include the data flow control settings 333-11 in which to apply to data communications associated with the mobile communication device 120-1.

Referring again to FIG. 16, the gateway 141 can be configured to control the flow of communications 1237 (such as data packets) to and from the mobile communication device 120-1 based on network address information in each of the respective data packets of communications 1237. For example, the communications 1237 communicated from the mobile communication device 120-1 include the network address XXXY indicating that the communications 1237 originate from the mobile communication device 120-1. The wireless access point 121-1 may further include a network address XXX1 to those communications (messages) communicated to the gateway 141. Accordingly, the gateway 141 is aware of the data flow (such as identified by the network address of the mobile communication device and/or the network address of the wireless access point 121-1) to which the received communications 1237 pertain.

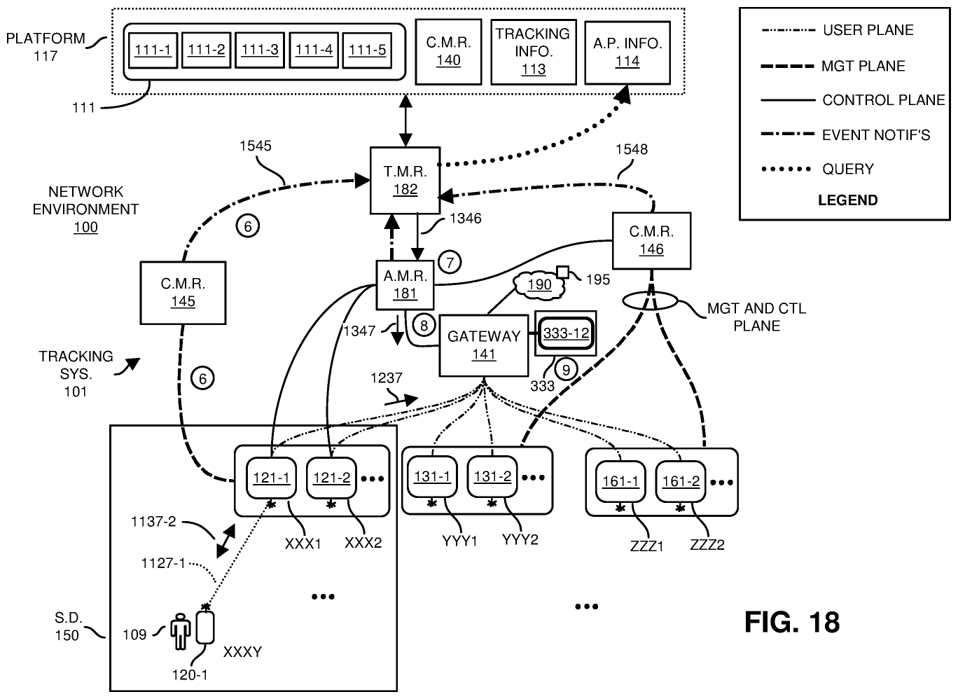

FIG. 18 is an example diagram illustrating updating of a respective data flow policy in response to a detected event and application of the updated data flow policy at a gateway according to embodiments herein.

In further examples, the communication management resource 145 (such as network management device) supports management plane functions associated with operation of the wireless access points 121 in the subscriber domain 150. More specifically, the communication management resource 145 can be configured as an element of the tracking system 101 that provides one or more operations such as configuring, monitoring, and providing management, monitoring and configuration services, etc., to one or more layers of the network stack and other parts of the tracking system 100.

As further shown, the communication management resource 145 can be configured to monitor data flow conditions (such as ability to support wireless connectivity and communication with the gateway 141) associated with the wireless access points 121 in the subscriber domain 150.

For example, in processing operation #6, assume that the communication management resource 145 monitors attributes such as including the data flow rate of communications through each of the wireless access points 121. The communication management resource 145 forwards any event notifications associated with operating conditions of the wireless access points 121 to the tracking management resource 182, which further updates the access point information 114 based on the received notifications.

Thus, based on feedback from the first wireless access point 121-1 and other wireless access points, the communication management resource 145 receives information associated with the wireless access points and/or information indicating a quality of service associated with the data flows of mobile communication device 120-1 supported by the wireless access point 121-1 and gateway 141. Via communications 1545, the communication management resource 145 notifies the tracking management resource 182 of the monitored operating conditions of the wireless access points such as an actual quality of service provided by the wireless access point 121-1 to the mobile communication device 120-1. The tracking management resource 182 updates the access point information 114 based on the received communications 1545.

Note that the examples of notifications from the communication management resource 145 to the tracking management resource 182 can include any notifications of operating conditions of the wireless access points 121 such as an amount of clients attached to the wireless access point 121-1, detected levels of co-channel interference associated with wireless communication link 1127-1 associated with wireless access point 121-1; detection of airtime conditions associated with the wireless communication link 1127-1 supporting wireless connectivity to each of multiple mobile communication devices in subscriber domain 150, amount of congestion associated with a corresponding CPU in the wireless access point 121-1 supporting data flow, amount of memory utilization in the wireless access point 121-1 potentially inhibiting traffic flow, health status router information associated with the wireless access point 121-1, unstable/stable wireline network backhaul conditions associated with the connectivity between the wireless access point 121-1 and the gateway 141, etc.

Any of the above monitored conditions by the communication management resource 145 may be favorable or unfavorable to supporting wireless connectivity between one or more of the wireless access points 121 and corresponding communication devices.

In further example embodiments, the tracking management resource 182 or other suitable entity updates the access point information 114 and respective abilities to support communications (data flows) based upon the received notifications from the communication management resource 145. The access point information 114 thus keeps track of the current operating conditions associated with each of the wireless access points 121 via the access point information 114 (such as an access point capability database).

As previously discussed, it is desirable to provide the mobile communication device 120-1 an appropriate level of service to which use 109 of the mobile communication device 120-1 subscribes. However, in certain instances, one or more of the wireless access points 121 may experience unfavorable operating conditions potentially preventing the one or more wireless access point from providing a desired level of service (such as bandwidth, latency, etc.). Assume that the wireless access point 121-1 experiences one or more unfavorable operating conditions such as: a high amount of clients attached to the wireless access point 121-1, high detected levels of co-channel interference associated with wireless communication link 1127-1 and with wireless access point 121-1; detection of low airtime conditions (low bandwidth) associated with the wireless communication link 1127-1 supporting wireless connectivity to each of multiple mobile communication devices in subscriber domain 150, high amount of congestion associated with a corresponding CPU in the wireless access point 121-1 inhibiting traffic flow, high amount of memory utilization in the wireless access point 121-1 inhibiting traffic flow through the wireless access point 121-1, poor router health status associated with the wireless access point 121-1, unstable wireline network backhaul conditions associated with the connectivity between the wireless access point 121-1 and the gateway 141, etc.

In such an instance, the tracking management resource 182 stores the one or more unfavorable conditions associated with the wireless access point 121-1 in the access point information 114. As previously discussed, the communication management resource 140 can be configured to use the tracking information 113 as well as corresponding access point information 114 to dynamically adjust the data flow control settings associated with each of the mobile communication devices depending upon the current operating conditions.

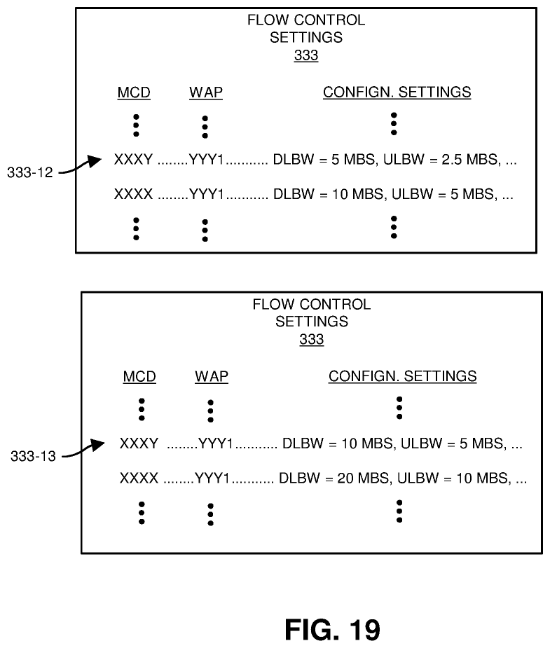

More specifically, in view of the detected unfavorable operating conditions as captured by the access point information 114, the communication management resource 140 can be configured to adjust the data flow control settings associated with the mobile communication device 120-1. For example, in response to detecting one or more of the unfavorable conditions as captured by the access point information 114 as previously discussed, the communication management resource 140 updates corresponding data flow control settings 333-11 associated with the gateway 141 providing throughput for the mobile communication device 120-1. In this example embodiment, in accordance with a respective subscription associated with the user 109 and/or mobile communication device 120-1, the mobile communication device 120 was initially provided in uplink bandwidth of 5 MBS and downlink bandwidth of 10 MBS during favorable conditions. In view of the detected one or more unfavorable operating conditions, the communication management resource 140 can be configured to reduce allocation of wireless bandwidth to the mobile communication device 120-1. For example, the communication management resource 140 produces updated flow control settings 333-12 (see FIG. 19) to indicate downlink bandwidth of 5 MBS assigned to the mobile communication device 120-1 and uplink bandwidth of 2.5 MBS to the mobile communication device 120-1. Thus, via the newly generated data flow control settings 333-12, the communication management resource 140 reduces the downlink bandwidth from 10 MBS to 5 MBS; the communication management resource 140 thus reduces the uplink bandwidth from 5 MBS to 2.5 MBS.

In processing operation #7 of FIG. 18, via communications 1346, the communication management resource 140 or tracking management resource 182 communicates the updated data flow configuration settings 333-12 to the authentication management resource 181. As further shown, via communications 1347 in processing operation #8, the authentication management resource 181 forwards the updated data flow configuration settings 333-12 to the gateway 141 in view of the unfavorable operating conditions associated with the mobile communication device 120-1.

In processing operation #9, the gateway 141 applies the new data flow configuration settings 333-12 to the communications 1237 (from 1137-2) associated with the mobile communication device 120-1. In other words, in accordance with application of the updated data flow control settings 333-12, the gateway 141 controls the downlink bandwidth associated with communications from the gateway 141 through the wireless access point 121-1 to the mobile communication device 120-1 to be 5 MBS instead of 10 MBS; the gateway 141 controls the uplink bandwidth associated with communications from the mobile communication device 120-1 through the wireless access point 121-1 to the gateway 141 and remote network 190 to be 2.5 MBS instead of 5 MBS.

In still further example embodiments, as previously discussed, it is desirable to provide the mobile communication device 120 an appropriate level of service to which the mobile communication device 120-1 subscribes (such as uplink 5 MBS, downlink 10 MBS) during favorable operating conditions. To this end, the communication management resource 140 can be configured to retrieve information indicating a respective quality of service to provide to the mobile communication device 120-1 assigned network address XXXY. The communication management resource 140 then compares the determined quality of service associated with the current data flow settings 333-12 to a threshold service level (such as 5 MBS uplink and 10 MBS downlink associated with the subscription) to which a user 109 of the mobile communication device 120-1 subscribes. Assuming that appropriate network resources are available to support the threshold service level again, the communication management resource 140 can be configured to adjust the data flow control settings 333 applied to the gateway 141 on an as needed basis to support the threshold service level to the mobile communication device 120-1.

More specifically, assume that the one or more of the wireless access points 121 now experiences more favorable operating conditions. For example, assume that the wireless access point 121-1 experiences more favorable operating conditions such as one or more of: a lower amount of clients attached to the wireless access point 121-1, lower detected levels of co-channel interference associated with wireless communication link 1127-1 and with wireless access point 121-1; detection of high airtime conditions associated with the wireless communication link 1127-1 supporting wireless connectivity to each of multiple mobile communication devices in subscriber domain 150, lower amount of congestion associated with a corresponding CPU in the wireless access point 121-1 inhibiting traffic flow, lower amount of memory utilization in the wireless access point 121-1 no longer inhibiting traffic flow through the wireless access point 121-1, better router health status associated with the wireless access point 121-1, stable wireline network backhaul conditions associated with the connectivity between the wireless access point 121-1 and the gateway 141, etc.

In such an instance, the tracking management resource 182 or other suitable entity receives this improved network condition information associated with the wireless access points 121 (such as via communications 1545) and stores it in the access point information 114 in a similar manner as previously discussed. As previously discussed, the communication management resource 140 can be configured to dynamically adjust the data flow control settings associated with each of the mobile communication devices depending upon the current operating conditions.

In view of the recent favorable or improved operating conditions as captured by the access point information 114 (and feedback from the wireless access points 120 and/or communication management resource 145), the communication management resource 140 can be configured to adjust the data flow control settings associated with the mobile communication device 120-1 to accommodate the threshold level of subscriber service (such as 5 MBS uplink and 10 MBS downlink) that quality of service level should be provided to the mobile communication device 120 during favorable conditions. For example, in response to detecting the now more favorable conditions as captured by the access point information 114, and determining that the wireless access point can provide such service, the communication management resource 140 updates corresponding data flow control settings 333-13 (see FIG. 19) associated with the gateway 141 providing throughput for the mobile communication device 120-1. In this example embodiment, in view of the detected one or more favorable operating conditions, the communication management resource 140 increases allocation of wireless bandwidth to the mobile communication device 120-1. For example, the communication management resource 140 produces updated flow control settings 333-13 (see FIG. 19) to indicate downlink bandwidth of 10 MBS assigned to the mobile communication device 120-1 and uplink bandwidth of 5 MBS to the mobile communication device 120-1. Thus, via the newly generated data flow control settings 333-13, the communication management resource 140 increases the downlink bandwidth from 5 MBS to 10 MBS; the communication management resource 140 thus increases the uplink bandwidth from 2.5 MBS to 5 MBS.

In processing operation #7, via communications 1346, the communication management resource 140 communicates the updated data flow configuration settings 333-13 to the authentication management resource 181. As further shown, via communications 1347, the authentication management resource 181 forwards the updated data flow configuration settings 333-13 to the gateway 141.

In processing operation #9, the gateway 141 applies the new data flow configuration settings 333-13 (in lieu of configuration settings 333-12) associated with the mobile communication device 120-1 to the communications 1237 associated with the mobile communication device 120-1. In other words, in accordance with the updated data flow control settings 333-13, the gateway 141 now controls the downlink bandwidth associated with communications from the gateway 141 through the wireless access point 121-1 to the mobile communication device 120-1 to be 10 MBS instead of 5 MBS; the gateway 141 controls the uplink bandwidth associated with communications from the mobile communication device 120-1 through the wireless access point 121-1 to the gateway 141 to be 5 MBS instead of 2.5 MBS. Thus, the mobile communication device 120-1 and corresponding user 109 are provided the subscriber level of service.

In a similar manner that communication management resource 145 provides operating condition feedback associated with wireless access points 121, the communication management resource 146 monitors operating conditions associated with wireless access points 131 and 161 and provides corresponding notifications of same to the tracking management resource 182 for storage in access point information 114.

In a similar manner, the tracking system 101 tracks locations of each of the mobile communication devices connected to the different wireless access points, monitors corresponding operating conditions of those wireless access points, and dynamically adjusts the corresponding data flow control settings provided to the mobile communication devices through the gateway 141 depending upon whether the monitored operating conditions of the wireless access points providing wireless service are favorable or unfavorable.

Accordingly, the system 101 and corresponding control functions as discussed herein: dynamically generate first control settings to control a first data flow associated with a first mobile communication device 120; apply the first control settings at the gateway 141 to control the first data flow, the first data flow supporting first communications through the gateway 141 between the first mobile communication device 120 and the remote network 190; dynamically generate second control settings to control a second data flow associated with a second mobile communication device 120-1, the second control settings different than the first control settings; and apply the second control settings at the gateway 141 to control the second data flow, the second data flow supporting second communications through the gateway 141 between the second mobile communication device 120-1 and the remote network 190. Accordingly, the communication management functions as discussed herein support individual control providing wireless connectivity to different mobile communication devices based on control of respective data flows through the gateway 141.

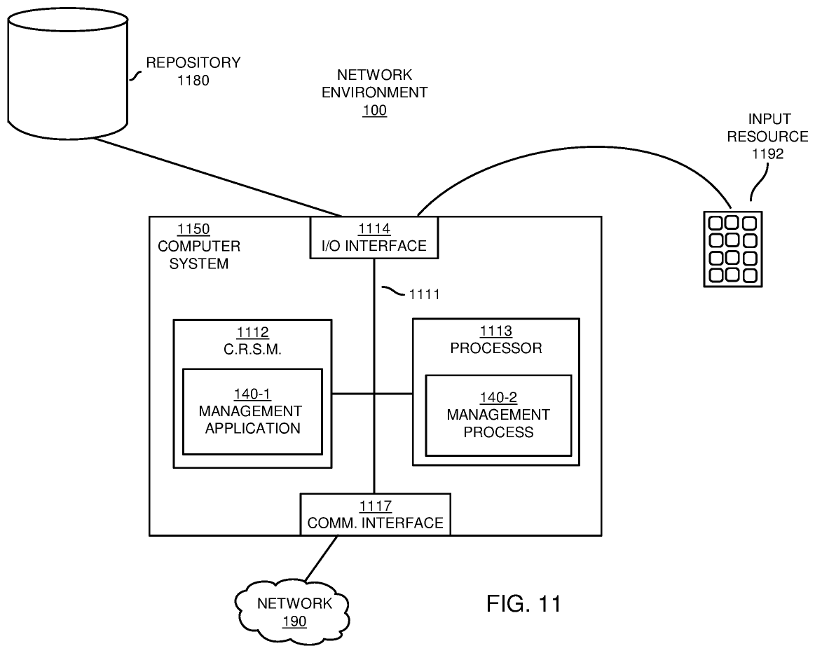

FIG. 11 is an example block diagram of a computer system for implementing any of the operations as previously discussed according to embodiments herein.

Any of the resources (such as communication management resource 140, communication management resource 145, communication management resource 146, tracking management resource 182, gateway 141, wireless access points, mobile communication device, etc.) as discussed herein can be configured to include computer processor hardware and/or corresponding executable instructions to carry out the different operations as discussed herein.

As shown, computer system 1150 of the present example includes an interconnect 1111 coupling computer readable storage media 1112 such as a non-transitory type of media (which can be any suitable type of hardware storage medium in which digital information can be stored and retrieved), a processor 1113 (computer processor hardware), I/O interface 1114, and a communications interface 1117.

I/O interface(s) 1114 supports connectivity to repository 1180 and input resource 1192.

Computer readable storage medium 1112 can be any hardware storage device such as memory, optical storage, hard drive, floppy disk, etc. In one embodiment, the computer readable storage medium 1112 stores instructions and/or data.

As shown, computer readable storage media 1112 can be encoded with management application 140-1 (e.g., including instructions) to carry out any of the operations as discussed herein.

During operation of one embodiment, processor 1113 accesses computer readable storage media 1112 via the use of interconnect 1111 in order to launch, run, execute, interpret or otherwise perform the instructions in management application 140-1. For the management application 140-1 stored on computer readable storage medium 1112. Execution of the communication management application 140-1 produces management process 140-2 to carry out any of the operations and/or processes as discussed herein.

Those skilled in the art will understand that the computer system 1150 can include other processes and/or software and hardware components, such as an operating system that controls allocation and use of hardware resources to execute communication management application 140-1.

In accordance with different embodiments, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1150 may reside at any location or can be included in any suitable resource in any network environment to implement functionality as discussed herein.

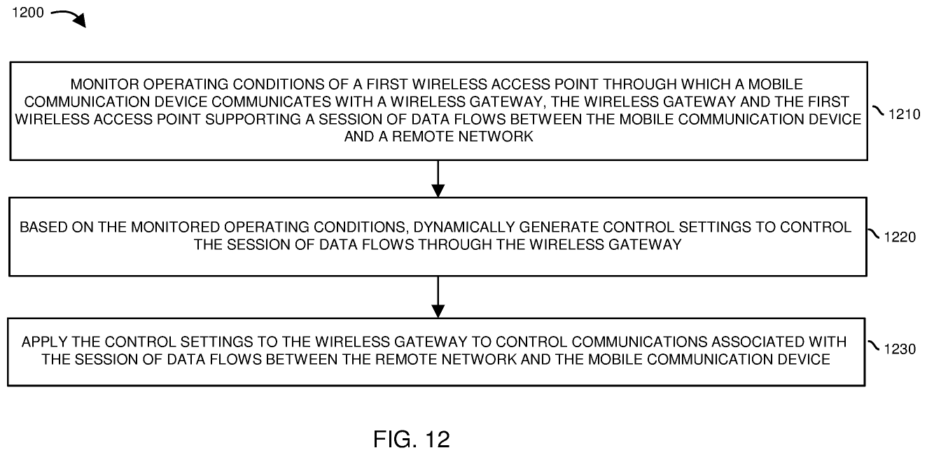

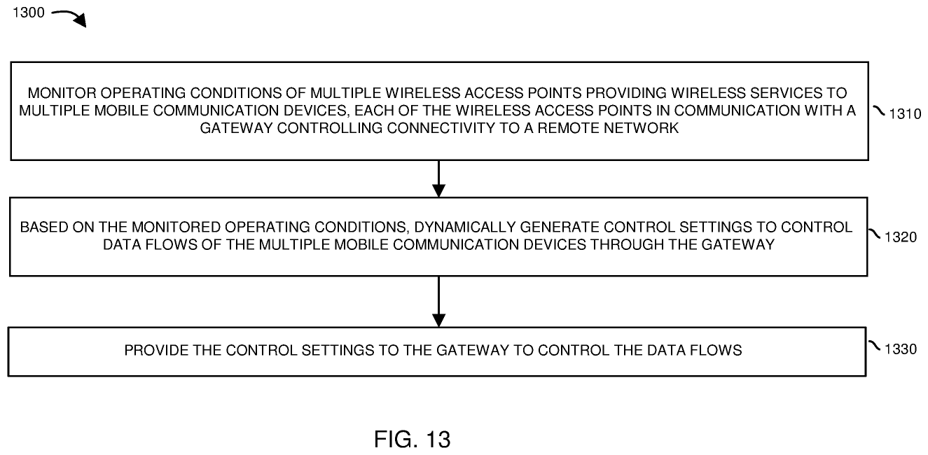

Functionality supported by the different resources will now be discussed via method flowcharts in FIGS. 12 and 13. Note that the steps in the flowcharts below can be executed in any suitable order.

FIG. 12 is a flowchart 1200 illustrating an example method according to embodiments. Note that there will be some overlap with respect to concepts as discussed above.

In processing operation 1210, the communication management resource 140 monitors operating conditions of a first wireless access point through which a mobile communication device 120 communicates with a gateway 141. The gateway 141 and the first wireless access point support a session of data flows between the mobile communication device 120 and a remote network 190.

In processing operation 1220, based on the monitored operating conditions, the controller 140 dynamically generates control settings 333 to control the session of data flows through the gateway 141.

In processing operation 1230, the communication management resource 140 applies the control settings to the gateway 141 to control communications associated with the session of data flows between the mobile communication device 120 and the remote network 190.

FIG. 13 is a flowchart 1300 illustrating an example method according to embodiments. Note that there will be some overlap with respect to concepts as discussed above.

In processing operation 1310, the communication management resource 140 tracks multiple mobile communication devices in wireless communication with multiple wireless access points via tracking information 113. Each of the wireless access points is in communication with a gateway 141, which controls connectivity to a remote network 190.

In processing operation 1320, the communication management resource 140 dynamically generates control settings to control data flows of the multiple mobile communication devices through the gateway 141 based on monitored operating conditions of the wireless access points.

In processing operation 1330, the communication management resource 140 provides the control settings to the gateway 141 to control the data flows associated with mobile communication devices.

Note again that techniques herein are well suited to control of data flows in a wireless network environment. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

We claim:

1. A method comprising:
monitoring operating conditions of a first wireless access point through which a mobile communication device communicates with a gateway, the gateway and the first wireless access point supporting a session of data flows between the mobile communication device and a remote network;
based on the monitored operating conditions, dynamically generating control settings to control the session of data flows through the gateway; and
applying the control settings to the gateway to control communications associated with the session of data flows between the mobile communication device and the remote network.

2. The method as in claim 1, wherein the first wireless access point is coupled to the gateway via a shared communication link.

3. The method as in claim 1, wherein the session of data flows is a first session of data flows, the method further comprising:
detecting a handoff of the mobile communication device from the first wireless access point to a second wireless access point;
monitoring operating conditions of the second wireless access point through which the mobile communication device communicates with the gateway, a combination of the gateway and the second wireless access point supporting a second session of data flows between the mobile communication device and the remote network;
based on the monitored operating conditions of the second wireless access point, dynamically generating second control settings to control the second session of data flows; and
applying the second control settings to the gateway to control communications associated with the second session of data flows between the mobile communication device and the remote network.

4. The method as in claim 3, wherein the first wireless access point resides in a subscriber domain in which a user of the mobile communication device domiciles; and
wherein the second wireless access point resides outside the subscriber domain.

5. The method as in claim 1, wherein the mobile communication device is in wireless communication with the first wireless access point via a Wi-Fi™ communication protocol.

6. The method as in claim 1 further comprising:
tracking movement of the mobile communication device through a wireless network environment of multiple wireless access points including the first wireless access point, the movement tracked based on detected handoffs of the mobile communication device from one wireless access point to another wireless access point in the wireless network environment;
monitoring operating conditions of each of the multiple wireless access points providing wireless services; and
updating respective control settings applied to the gateway based on the operating conditions of the multiple wireless access points.

7. The method as in claim 1 further comprising:
generating the control settings in response to receiving a message from the gateway, the message providing notification of the gateway receiving the communications from the wireless access point.

8. The method as in claim 1 further comprising:
determining the operating conditions based on feedback from the first wireless access point.

9. The method as in claim 8, wherein dynamically generating the control settings includes:
determining a threshold level of wireless service to be provided to the mobile communication device; and
adjusting the control settings applied to the gateway to support the threshold level of wireless service.

10. The method as in claim 9 further comprising:
applying the adjusted control settings to the gateway to control the communications associated with the data flows through the gateway.

11. A system comprising:
communication management hardware operative to:
monitor operating conditions of a first wireless access point through which a mobile communication device communicates with a gateway, the gateway and the first wireless access point supporting a session of data flows between the mobile communication device and a remote network;
based on the monitored operating conditions, dynamically generate control settings to control the session of data flows through the gateway; and
apply the control settings to the gateway to control communications associated with the session of data flows between the mobile communication device and the remote network.

12. The system as in claim 11, wherein the first wireless access point is coupled to the gateway via a shared communication link; and
wherein the communication management hardware is further operative to dynamically generate the control settings based on the monitored operating conditions and capabilities of the mobile communication device to support communications.

13. The system as in claim 11, wherein the session of data flows is a first session of data flows, the communication management hardware operative to:
detect a handoff of the mobile communication device from the first wireless access point to a second wireless access point;
monitor operating conditions of the second wireless access point through which the mobile communication device communicates with the gateway, a combination of the gateway and the second wireless access point supporting a second session of data flows between the mobile communication device and the remote network;
based on the monitored operating conditions of the second wireless access point, dynamically generate second control settings to control the second session of data flows; and
apply the second control settings to the gateway to control communications associated with the second session of data flows between the mobile communication device and the remote network.

14. The system as in claim 13, wherein the first wireless access point resides in a subscriber domain in which a user of the mobile communication device domiciles; and
wherein the second wireless access point resides outside the subscriber domain.

15. The system as in claim 11, wherein the mobile communication device is in wireless communication with the first wireless access point via a Wi-Fi™ communication protocol.

16. The system as in claim 11, wherein the communication management hardware is further operative to:
track movement of the mobile communication device through a wireless network environment of multiple wireless access points including the first wireless access point, the movement tracked based on detected handoffs of the mobile communication device from one wireless access point to another wireless access point in the wireless network environment;
monitor operating conditions of each of the multiple wireless access points providing wireless services; and
update respective control settings applied to the session of data flows supported by the gateway based on the operating conditions of the multiple wireless access points.

17. The system as in claim 11, wherein the communication management hardware is further operative to:
generate the control settings in response to receiving a message from the gateway, the message providing notification of the gateway receiving the communications from the wireless access point.

18. The system as in claim 11, wherein the communication management hardware is further operative to:
determine the operating conditions based on feedback from the first wireless access point.

19. The system as in claim 18, wherein the communication management hardware is further operative to:
determine a threshold level of wireless service to be provided to the mobile communication device; and
adjust the control settings applied to the gateway to support the threshold level of wireless service.

20. The system as in claim 19, wherein the communication management hardware is further operative to:
apply the adjusted control settings to the gateway to control the communications associated with the session of data flows through the gateway.

21. Computer-readable storage hardware having instructions stored thereon, the instructions, when carried out by computer processor hardware, cause the computer processor hardware to:
monitor operating conditions of a first wireless access point through which a mobile communication device communicates with a gateway, the gateway and the first wireless access point supporting a session of data flows between the mobile communication device and a remote network;
based on the monitored operating conditions, dynamically generate control settings to control the session of data flows through the gateway; and
apply the control settings to the gateway to control communications associated with the session of data flows between the remote network and the mobile communication device.

22. A method comprising:
tracking multiple mobile communication devices in wireless communication with multiple wireless access points, each of the wireless access points in communication with a gateway controlling connectivity of the mobile communication devices to a remote network;
dynamically generating control settings to control data flows of the multiple mobile communication devices through the gateway based on monitored operating conditions of the wireless access points; and
providing the control settings to the gateway to control the data flows of the multiple mobile communication devices.

23. The method as in claim 22, wherein dynamically generating control settings includes:
generating first control settings to control a first data flow associated with a first mobile communication device of the multiple mobile communication devices;
applying the first control settings at the gateway to control the first data flow, the first data flow supporting first communications through the gateway between the first mobile communication device and the remote network;
generating second control settings to control a second data flow associated with a second mobile communication device, the second control settings different than the first control settings; and
applying the second control settings at the gateway to control the second data flow, the second data flow supporting second communications through the gateway between the second mobile communication device and the remote network.

24. The method as in claim 1, wherein the operating conditions include a capability of the first wireless access point to support wireless communications with the mobile communication device; and
wherein the communication management hardware is further operative to generate corresponding control settings for each of multiple mobile communication devices on a per mobile communication device basis.

25. The method as in claim 1, wherein the monitored operating conditions include an ability of the first wireless access point to support communications between the first wireless access point and the gateway.

26. The method as in claim 11, wherein the communication management hardware is further operative to:
determine capabilities of the mobile communication device to support communications; and
dynamically generate the control settings to control the session of data flows through the gateway based on the monitored operating conditions and the determined capabilities of the mobile communication device.
